(19) United States
(12) Patent Application Publication
(10) Pub. No.: US 2007/0245069 A1
(43) Pub. Date: Oct. 18, 2007

(54) Storage Device, Memory Management Method and Program

(76) Inventor: Syuichi Kikuchi, Iwate (JP)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/547,181

(22) PCT Filed: Sep. 8, 2005
(86) PCT No.: PCT/JP05/17001

§ 371 Date: Jun. 11, 2007

(30) Foreign Application Priority Data
Sep. 10, 2004 (JP) 2004-263995

(51) Int. Cl. G06F 12/00

(52) U.S. Cl. 711/103; 711/170

(57) ABSTRACT

A physical group address is allocated to a storage area of a flash memory (11) for each group as units smaller than a block as units of data erasing, and the group includes multiple pages and the page includes multiple columns. When writing data and a logical address of a writing destination are supplied, a CPU (121) writes the data in a column in the group indicated by a writing pointer to associate the supplied logical address with the column. A relationship between the physical group address of the group having this column and the logical group address is stored in a logical/physical conversion table of a RAM (123). Data stored in the block is erased when the number of blocks having no empty block reaches a predetermined number or less.

### TECHNICAL FIELD

The present invention relates to a storage device suitable for suppressing a reduction in access efficiency due to data erasing along with data rewriting, and relates to memory management method for managing a storage area of the storage device, and a program.

### BACKGROUND ART

An EEPROM (Electrically Erasable/Programmable Read Only Memory) flash memory is used as a storage medium accessible (data readable/writable and erasable) by a computer.

Data erase of the flash memory is performed on a basis of units of a storage capacity, which is called block. In the flash memory, there is difficulty in insufficient prevention of occurrence of a defective memory block where data is not normally stored in the process of manufacture. Accordingly, in some cases, arrangement of normal memory blocks becomes physically discontinuous due to defective memory blocks. International Publication No. WO99/30239 discloses a storage device that facilitates access to the memory block even if the memory blocks are physically discontinuous arranged. According to this disclosure, in the memory blocks of the flash memory, continuous logical addresses separately from physical addresses are allocated dynamically by the flash memory. Moreover, an address conversion table representing a relationship with the logical address is created by the flash memory. Then, the physical memory address is converted to the logical memory address, thereby suppressing a reduction in efficiency of access to the flash memory caused by discontinuous memory blocks.

In the conventional flash memory, allocation of physical memory addresses is performed on a block-by-block basis. For specifying a page from the logical memory address, a page address, which represents an order of pages in the block, is used in addition to the physical memory address associated with the logical memory address, thereby specifying the page. Additionally, assuming that data is stored in order from a first sector in the same block, data that is continuously supplied (for example, data that makes up one file) is stored in continuous pages in the same block. Accordingly, in rewriting data, it is necessary to keep the order of the pages where rewriting data is stored in the block. More specifically, first of all, the flash memory transfers non-rewriting data from a transfer source block where rewriting data is stored to a transfer destination empty block in such a way that the order of data is maintained. Namely, data on an n-th page in the transfer source block is transferred to an n-th page in the transfer destination where n (an integer of 1 or more) is an order of pages. Moreover, rewriting data is rewritten by the flash memory in such a way that the order of rewritten data is maintained to be the same as that of non-rewriting data. In other words, data, which is obtained by rewriting data on an m-th page in a copy source block, is transferred to an m-th page in the transfer destination where m (an integer of 1 or more) is an order of pages. Then, the flash memory erases the storage contents stored in the transfer source block.

In this data erase processing, data in the block where data should be erased is all erased. For example, in rewriting an extremely small amount of data as compared with a storage capacity for one block, a page where data, which is not related to the corresponding data is stored, is initialized, and an empty page where no data is stored is initialized. Namely, even when the amount of rewriting data is small, much data, which is stored in the page on a block-by-block basis, must be erased.

For this reason, data erasing process with poor efficiency is frequently performed to rewrite the small amount of data, resulting in deterioration in efficiency of access to the memory.

Particularly, when an OS (Operating System) manages the storage contents of the flash memory in the same way as the case in which a hard disk device or a flexible disk manages the storage contents, efficiency of access to the flash memory worsens. Namely, an FAT (File Allocation Table), which is managed by the OS and which indicates a relationship between the respective data and the logical addresses at which these data is stored, is written in the flash memory and updated frequently. Since an amount of data in the FAT is generally extremely small as compared with the storage contents for one block, data erasing process with poor efficiency is frequently performed along with rewriting of FAT.

Furthermore, a flash memory with an extremely large storage capacity per block (e.g., one block includes 65 pages and one page has a storage capacity of about 2 K bytes) has been recently manufactured. In the case where the storage contents of such the flash memory are managed by the aforementioned conventional method, data erasing process of a massive storage area is performed along with rewriting of the small amount of data, thereby causing deterioration in efficiency of access to the flash memory.

Moreover, in the case where data erase processing is performed along with rewriting of an electric file, the data must be saved to another block in order to keep data, which is not related to the electric file and has to be still stored. Accordingly, in general, the worse efficiency of data erasing process is, the more processing required to save data is increased, thereby preventing smooth access to the flash memory.

Particularly, regarding data erasing process of the flash memory with an extremely large storage capacity per block, an amount of data to be saved per one time is vastly increased, making it extremely difficult to perform smooth access to the flash memory.

### DISCLOSURE OF INVENTION

In view of the aforementioned circumstances, it is an object of the present invention to provide a storage device suitable for suppressing a reduction in access efficiency due to data erasing along with data rewriting, and a memory management method. Moreover, it is an object of the present invention to provide a storage device suitable for performing access to a storage area smoothly and a memory management method.

In order to attain the above object, a storage device according to a first aspect of the present invention includes a storing section (11) including multiple memory blocks as storage areas for storing user data, each memory block being formed by combining multiple groups each having a storage capacity smaller than the memory block, and each group being formed by combining multiple pages each having a storage capacity smaller than the group; a table storing section (123) that stores a first table (61) for associating a physical group address indicating a physical position of the group in the storage area with a logical group address indicating a logical position of the group; a pointer storing section (123) that obtains an empty group where user data is storable from the group to store a pointer indicating a physical group address of the obtained empty group; and a writing section (12), upon supply of the user data, a logical group address indicating a group in which the user is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61).

According to the aforementioned storage device, user data is written in units smaller than the block, thereby eliminating the need for an operation in which a new empty block (block in which no user data is stored) is searched and user data is written to the new empty block every time when user data is written. Then, data erasing to the block may not have to be performed at the time of writing user data. Moreover, processing for transferring an unchanged portion along with data writing is performed in units smaller than the block. Accordingly, a reduction in efficiency of access to the storage device can be suppressed.

Moreover, in this storage system, the relationship between the logical address and the physical address is managed in units smaller than the block and larger than the page or the column. Accordingly, the storage capacity of the table, which stores data indicating the relationship between the logical address and the physical address, can be reduced as compared with the case in which the management on the relationship between the logical address and the physical address is performed on a page-by-page or column-by-column basis. Furthermore, the management on the relationship between the logical address and the physical address is accurately performed as compared with the case in which the management is performed on a block-by-block basis.

Moreover, the writing section (12) may include a user data invalidating section (12) that associates the logical group address of the group to which a storage position where new user data is written belongs with data indicating that user data stored at other storage position designated by the inner group address of the storage position is unnecessary data; an erasing target designating section (12) that designates a memory block where data should be erased from the memory blocks that store user data determined as being unnecessary by the user data invalidating section (12) and; an erasing section (12) that determines whether user data stored in the memory block designated by the erasing target designating section (12) is necessary, and transfers the user data to another memory block when determining as being necessary, and further erases data stored by the memory block designated by the erasing target designating section (12).

Furthermore, the storage device may further include a storing section (123) that stores a second table (51) including information for identifying whether an empty block is included in the memory block wherein the writing section (12) may include a first updating section (12) that writes information indicating that the memory block includes no empty group in the second table (51) when the empty group is eliminated from the memory block including the group as a result of writing the supplied user data to the empty block; and a second updating section (12) that writes information, indicating that the memory block from which data is erased by the erasing section (12) includes an empty block, in the second table (51), and the erasing target designating section (12) may designate a target memory block from which data should be erased from the memory blocks where information indicating that no empty group is included is written in the second table (51).

Moreover, the writing section (12) may include an empty block number determining section (12) that determines whether the number of memory blocks including the empty group meets a predetermined condition wherein the erasing target designating section (12) may designate a target memory block from which data should be erased from the memory blocks that store unnecessary user data when determining that the number of memory blocks including the empty group does not meet the predetermined condition.

Furthermore, the physical group address may be cyclically assigned ranking and include a block address indicating a block to which the group indicated by the physical group address belongs; and the erasing target designating section (12) may designate a block, having a first block address after a block from which data is erased last among the memory blocks that store unnecessary user data, as a target block from which data should be erased.

Moreover, the second table (51) may further include information for identifying whether unnecessary user data is included in each memory block; the user data invalidating section (12) may include a writing section (12) that writes information, indicating that unnecessary user data is stored in the memory block including the other storage position designated by the logical group address of the group to which the storage position in which new user data is written belongs and the inner group address of the storage position, in the second table (51); and the erasing target designating section (12) may designate a target memory block from which data should be erased from the memory blocks in which information, indicating that unnecessary user data is stored, is written.

Furthermore, the physical group address may be cyclically assigned ranking; and the pointer storing section (123) may obtain a first empty group among empty groups each having a physical group address after physical group addresses of the group where a page in which user data can be stored is eliminated as a result of writing the user data.

Moreover, the storage device may further includes a reading section (12), upon supply of a logical group address of a group in which user data is to be read, and an inner group address that designates a storage position in which the user data is stored in a page belonging to the group, that obtains a physical group address associated with the logical group address based on an address conversion table and further reads user read from the storage position designated by the inner group address in the page belonging to the group indicated by the obtained physical group address.

Furthermore, the storage device may further include a code generating section (12) that performs mathematical computations based on the contents of storing user data to generate an error correction code; and a code storing section (11) that stores the error correction code generated by the code generating section (12) wherein the reading section (12) may determine whether the user data is correctly read based on the read user data and the error correction code stored by the code storing section (11), and restore the user data based on the error correction code to replace the restored data with user data when the user data is not correctly read.

Moreover, the page may include one or more columns, and the inner group address at the storage position of the column may include an inner group page address that designates a logical position of a page including the column in the group and a column address that designates a logical position of the column in the page.

Furthermore, the physical group address stored by the first table (61) may include a physical address allocated for each set of groups and an address indicating a logical position in the set of groups.

Moreover, the storage device may further includes a list storing section (123) that stores a list for associating a physical address of a table storage area that stores the first table (61), which is stored in the storing section (11), with an address indicating a logical position in the table storage area wherein the writing section (12) may acquire the physical address based on the address indicating the logical position in the table storage area, and obtain the logical group address based on the data stored in the storage area corresponding to the acquired physical address.

Furthermore, the storage device may further include a second pointer storing section (123) that obtains an empty group being in a state that stored user data can be copied from the group to store a pointer indicating a physical group address of the obtained empty group wherein the writing section (12) may copy the user data to the empty group indicated by the pointer stored by the second storing section (123) when the stored user data is copied to the empty group, and further write data, which associates the logical group in which the user data is stored with the physical group address of the empty group, in the table.

A memory management method according to a second aspect of the present invention is a memory management method for managing a storing section (11) including multiple memory blocks as storage areas for storing user data, each memory block being formed by combining multiple groups each having a storage capacity smaller than the memory block, and each group being formed by combining multiple pages each having a storage capacity smaller than the group; the memory management method including the table storing step of storing a first table (61) for associating a physical group address indicating a physical position of the group in the storage area with a logical group address indicating a logical position of the group; the pointer storing step of obtaining an empty group where user data is storable from the group to store a pointer indicating a physical group address of the obtained empty group; and the writing step, upon supply of the user data, a logical group address indicating a group in which the user data is to be written, an inner group address indicating a storage position where the user data in a page belonging to the group, of writing the user address at the storage position indicated by the inner group address of the page belonging to the empty group indicated by the pointer and further writing data for associating the physical group address of the empty group with the supplied logical group address in the first table (61).

According to the aforementioned storage device, user data is written in units smaller than the block, thereby eliminating the need for an operation in which a new empty block (block in which no user data is stored) is searched and user data is written to the new empty block every time when user data is written. Then, data erasing with poor efficiency to the block may not have to be performed at the time of writing user data. Moreover, processing for transferring an unchanged portion along with data writing is performed in units smaller than the block. Accordingly, a reduction in efficiency of access to the storage device can be suppressed.

Moreover, in this storage system, the relationship between the logical address and the physical address is managed in units smaller than the block and larger than the page or the column. Accordingly, the storage capacity of the table, which stores data indicating the relationship between the logical address and the physical address, can be reduced as compared with the case in which the management on the relationship between the logical address and the physical address is performed on a page-by-page or column-by-column basis. Furthermore, the management on the relationship between the logical address and the physical address is accurately performed as compared with the case in which the management is performed on a block-by-block basis.

A program according to a third aspect of the present invention is a program causing a computer, being connected to a storing section (11) including multiple memory blocks as storage areas for storing user data, each memory block being formed by combining multiple groups each having a storage capacity smaller than the memory block, and each group being formed by combining multiple pages each having a storage capacity smaller than the group, to execute the function as a table storing section (123) that stores a first table (61) for associating a physical group address indicating a physical position of the group in the storage area with a logical group address indicating a logical position of the group; the function as a pointer storing section (123) that obtains an empty group where user data is storable from the group to store a pointer indicating a physical group address of the obtained empty group; and the function as a writing section (12), upon supply of the user data, a logical group address indicating a group in which the user data is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61).

According to the computer that executes such the program, writing of user data is performed in units smaller than the block, thereby eliminating the need for an operation in which a new empty block (block in which no user data is stored) is searched and user data is written to the new empty block every time when user data is written. Then, data erasing with poor efficiency to the block may not have to be performed at the time of writing user data. Moreover, processing for transferring an unchanged portion along with data writing is performed in units smaller than the block. Accordingly, a reduction in efficiency of access to the storage device can be suppressed.

Moreover, in this storage system, the relationship between the logical address and the physical address is managed in units smaller than the block and larger than the page or the column. Accordingly, the storage capacity of the table, which stores data indicating the relationship between the logical address and the physical address, can be reduced as compared with the case in which the management on the relationship between the logical address and the physical address is performed on a page-by-page or column-by-column basis. Furthermore, the management on the relationship between the logical address and the physical address is accurately performed as compared with the case in which the management is performed on a block-by-block basis.

According to the present invention, it is possible to provide a storage device suitable for suppressing a reduction in access efficiency due to data erasing along with data rewriting and a memory management method.

Moreover, according to the present invention, it is possible to provide a storage device suitable for performing access to a storage area smoothly and a memory management method.

### BRIEF DESCRIPTION OF DRAWINGS

These objects and other objects and advantages of the present invention will become more apparent upon reading of the following detailed description and the accompanying drawings in which:

FIG. 1 is a block diagram illustrating a configuration of a storage system according to an embodiment of the present invention;

FIG. 2 is a view schematically illustrating a logical structure of a storage area of a flash memory;

FIG. 3 is a view schematically illustrating a logical structure of a block;

FIG. 4 is a view schematically illustrating a data structure of each of a directory and an FAT;

FIG. 5 is a view schematically illustrating a data structure of a block state table;

FIG. 6 is a view schematically illustrating a data structure of a logical physical conversion table;

FIG. 7 is a flowchart illustrating data reading process;

FIG. 8 is a flowchart illustrating data writing process;

FIG. 9 is a flowchart continued from the flowchart illustrating data writing process;

FIG. 10 is a flowchart continued from the flowchart illustrating data writing process;

FIG. 11 is a flowchart continued from the flowchart illustrating data writing process;

FIG. 12 is a flowchart continued from the flowchart illustrating data writing process;

FIG. 13 is a flowchart illustrating empty block ensuring process;

FIG. 14 is a flowchart illustrating group registration process;

FIG. 15 is a view illustrating a relationship between a physical group address allocated for each set of groups and a temporary physical group address representing a logical position in a set of groups;

FIG. 16 is a view illustrating an example of a logical/physical conversion table stored in a memory area of a flash memory;

FIG. 17 is a view illustrating an example of a list that associates a physical address of a table storage area, which stores a logical/physical conversion table, with an address indicating a logical position in the table storage area;

FIG. 18 is a view illustrating an example of a block state table stored in a storage area of a flash memory; and

FIG. 19 is a view illustrating an example of a list that associates a physical address of a table storage area, which stores a block state table, with an address indicating a logical position in the table storage area.

### BEST MODE FOR CARRYING OUT THE INVENTION

The following will explain an embodiment of the present invention using a storage system having a flash memory as an example with reference to the drawings.

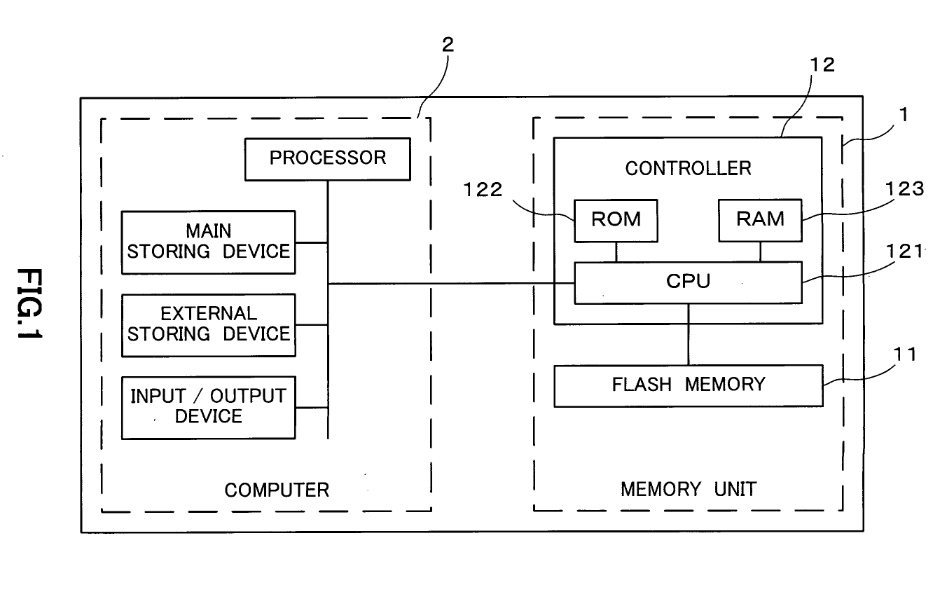

FIG. 1 is a block diagram illustrating a physical configuration of a storage system according to an embodiment of the present invention.

As illustrated in this figure, the storage system includes a memory unit 1 and a computer 2. The memory unit 1 is attached to the computer 2 via an internal bus which computer 2 has. Additionally, for example, as illustrated in FIG. 1, the memory unit 1 and the computer 2 may be incorporated into the same housing.

The memory unit 1 includes a flash memory 11 and a controller 12.

The flash memory 11 includes, for example, a storage device such as an EEPROM and a sequencer such as a logic circuit.

The flash memory 11 stores (writes) data supplied from the computer 2, reads stored data, supplies stored data to the computer 2, and erases stored data in response to a request from the controller 12.

Moreover, in connection with each of data writing, reading, and erasing operations, the flash memory 11 generates information representing whether the operation is performed (busy state) and status information representing whether the erasing operation is normally performed, and supplies the result to the controller 12.

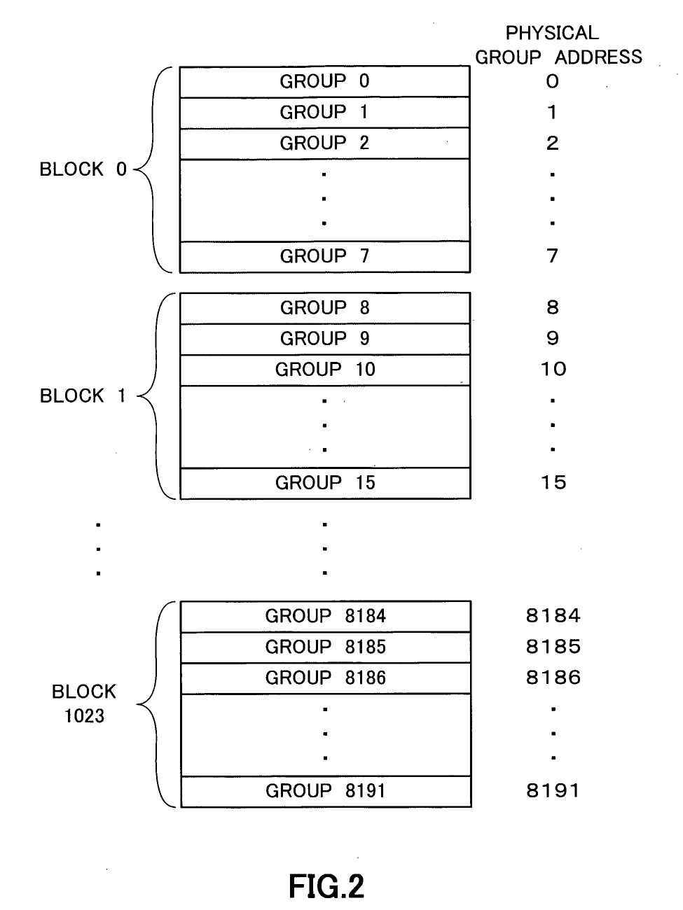

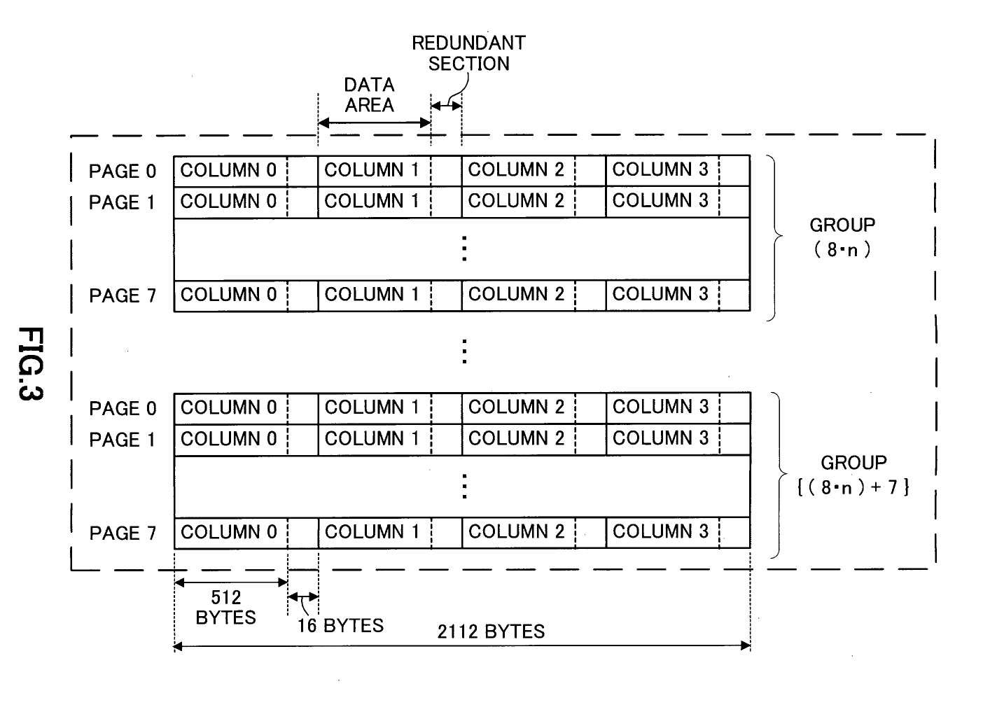

FIG. 2 and FIG. 3 are views each illustrating one structural example of a storage area which the flash memory 11 has.

The storage area, which the flash memory 11 has, is composed of, for example, 1024 blocks as illustrated in FIG. 2. Data is erased on a block-by-block basis. Physical block addresses of 0 to 1023 are sequentially allocated to the respective blocks from the top of the block in order.

Each block includes, for example, 8 groups as illustrated in FIG. 2 and FIG. 3. In the example illustrated in FIG. 2, the entire storage area of the flash memory 11 is composed of 8192 groups.

Physical group addresses of 0 to 8191 are sequentially allocated to the respective groups from the head of the storage area of the flash memory 11 in order. Accordingly, as illustrated in, for example, FIG. 3, eight groups where the physical group address is (8·n) or more to {(8·n)+7} or less are included in the block where the physical address is n (n is an integer of 0 or more and 1023 or less). In other words, when the physical group address of the group is expressed in a binary number of 13 bits, the higher-order 10 bits of the binary number correspond to the physical block address of the block to which the group belongs.

Each group includes, for example, 8 pages as illustrated in FIG. 3. Regarding each group, inner group addresses of 0 to 7 are continuously allocated to the respective pages in the group from the top page in the group in order. While, each page of the flash memory 11 includes 2112 memory cells in total where each storage capacity is one byte. Addresses of 0 to 2111 are continuously allocated to the respective memory cells from the top of the page in order.

Additionally, an inner block page address has 6 bits in total where the inner group page address of the page is specified as low-order 3 bits and low-order 3 bits of the physical group address of the group to which the page belongs is specified as high-order 3 bits.

Each page includes four columns each having a storage area of, for example, 528 (=512+16) bytes as illustrated in FIG. 3. Column addresses of 0 to 3 are continuously allocated to the respective columns included in each page from the top in order. For example, in the example illustrated in FIG. 2, the entire storage capacity of the flash memory 11 is 132 Mbytes.

Each column includes a data area with a 512 byte area from the top and a redundant section with a tail of 16 bytes as illustrated in FIG. 3.

User data is stored in the data area. User data herein is data that is input from the computer 2 and stored in the flash memory 11 or data that is stored in the flash memory 11 and input to the computer 2 by the flash memory 11.

In the redundant section, for example, a defective block flag, an old group flag, and an ECC (Error Correcting Code) are stored.

The defective block flag is a flag indicating that the block including the redundant section is a block (defective block) that cannot normally store data.

The old group flag is a flag indicating that user data, which is stored in the data area in the group to which the column including the redundant section belongs, is old data to be treated as unnecessary data (hereinafter called old data).

The ECC is data for checking whether the contents of user data stored in the data area corresponding to the redundant section are not broken.

The computer 2 recognizes the data area of each column as one section of 512 bytes when accessing to the flash memory 11. Namely, the sector is a minimum unit when the computer 2 gains access to the flash memory 11. Then, the logical address is allocated to each sector.

The position of the column is specified using the column address of the column, the inner group page address of the page to which the column belongs and the physical group address of the group to which the column belongs. Data, which includes three addresses, i.e., the column address, the inner group page address, and the physical group address, and which designates the column, is hereinafter called column physical address.

For example, the column physical address includes an upper digit, a middle digit, and a lower digit. The upper digit is a logical group address of the group to which the column belongs. The middle digit is an inner group page address of the page to which the column belongs. The lower digit is a column address of the column. The total number of physical addresses may be a predetermined value, which is equal to or more than the total number of columns which the flash memory 11 physically includes.

When an instruction to erase data of a specific block is sent from the controller 12 of the memory unit 1, the flash memory 11 erases the storage contents of all memory cells included in the corresponding block. More specifically, for example, when the flash memory 11 includes an NAND flash memory, a storage value of each memory cell is rewritten to “1.”

Furthermore, a directory and an FAT (File Allocation Table) are stored in the data area of the flash memory 11. It is noted that processing for updating the data area is described later.

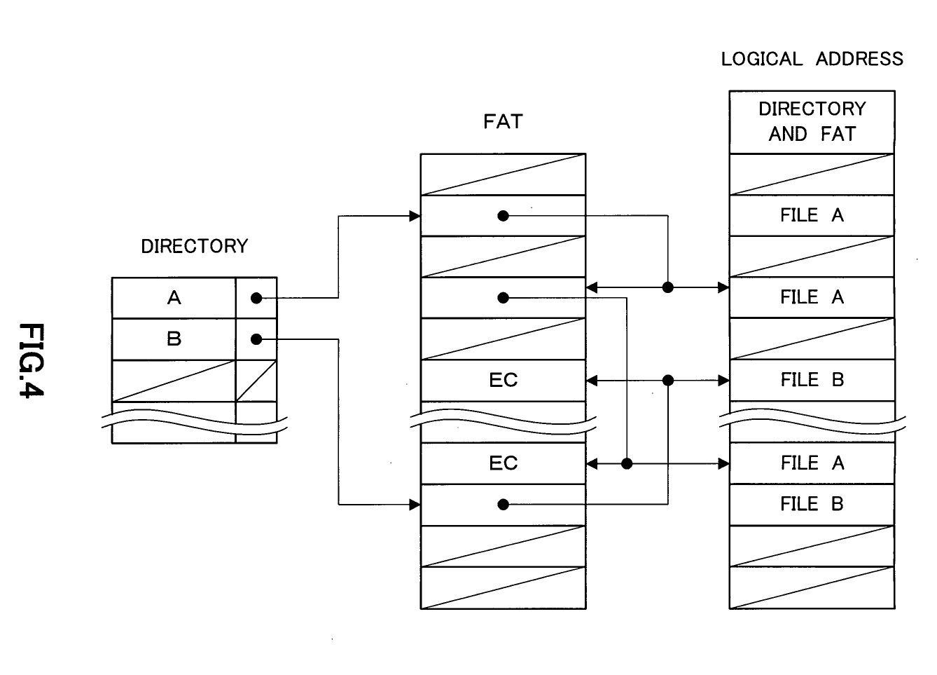

For example, FIG. 4 is a view illustrating a relationship among the directory, the FAT, and the logical block address when an MS-DOS (registered trademark) filing system is applied to the flash memory 11.

Additionally, the logical address, which meets a predetermined condition, is allocated to the sector corresponding to the column in which information of the directory and FAT is stored. More specifically, for example, top 4096 addresses (namely, addresses of 00000 and more to 00FFFh and less) are added as logical addresses. It is noted that a number ending in “h” is a hexadecimal number in the present specification and drawings.

The directory is a table indicating a file name of an electric file (i.e., set of data designated by the computer 2 as an object to be collectively processed) stored in the flash memory 11 and a logical address of a sector where a head portion of the file is stored.

The FAT is a table indicating a file position in the storage area of the flash memory 11. Then, when the file does not fit in one column, the FAT stores a logical address of a column that stores the following portion as illustrated in FIG. 4. Regarding a logical address of a column that stores an end portion of the file, an end code (EC) is added thereto as illustrated in FIG. 4 to indicate that the logical address is the end portion.

As illustrated in FIG. 1, the controller 12 includes a CPU (Central Processing Unit) 121, a ROM (Read Only Memory) 122, and a RAM (Random Access Memory) 123. The RAM 123 includes, for example, a backed-up SRAM (Static RAM) or a FeRAM (Ferroelectric RAM). At least a part of the storage area of the RAM 123 includes a nonvolatile storage area.

The CPU 121 is connected to the ROM 122, the RAM 123, the flash memory 11, and the computer 2.

The CPU 121 executes processing (to be described later) according to a program prestored in the ROM 122 by manufacturers of the controller 12 to control the memory unit 1.

Then, when obtaining a command supplied from the computer 2, the CPU 121 executes processing corresponding to the command. The command received by the CPU 121 includes a command for accessing to the flash memory 11.

The storage area, which the RAM 123 has, includes a temporary storage area used as a working area for the CPU 121. Moreover, the RAM 123 includes a nonvolatile storage area. The nonvolatile storage area stores a block state table 51, a logical/physical conversion table 61, which are prepared in processing (to be described later) by the CPU 121, a writing pointer, a writing pointer initial value, a moving destination writing pointer, and an empty block number counter.

The temporary storage area is a storage area for temporarily storing data stored in a block including a writing page in data writing process to be described later. Moreover, the temporary storage area has a storage capacity for one page of the flash memory 11. It is noted that the storage capacity of the temporary storage area may be larger than one page of the flash memory.

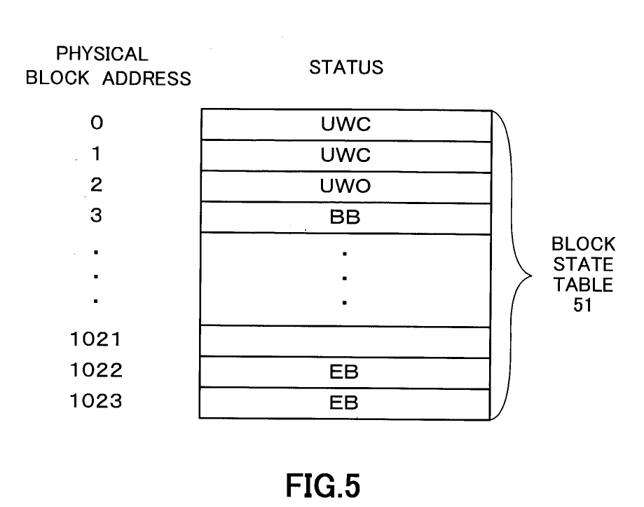

The block state table 51 stores information indicating the following states (1) to (3), (4a) and (4b) of the respective blocks contained in the storage area of the flash memory 11 as illustrated by, for example, the data structure that is schematically shown in FIG. 5. Namely, the following five block states are shown:

(1) Defective block

(2) Non-defective block, i.e., good block (empty block): there is no group where data is written in the good block;

(3) Good block: a group where data is written and a group where no data is written are mixed in the good block;

(4a) Good block: data is written in all groups belonging to the good block and invalid data (old data) among these written data is not included therein; and

(4b) Good block: old data among data written in the good block is included therein.

The block state table 51 stores information, which indicates any one of these states, to be associated with the physical block address of the block. Additionally, in FIG. 5, data indicating state (1) is shown by “BB”, data indicating state (2) is shown by “EB”, data indicating state (4a) is shown by “UWO”, and data indicating state (4b) is shown by “UWC.” Moreover, data indicating state (3) is shown by a blank space.

The block state table 51, for example, is prepared in advance in the nonvolatile storage area of the RAM 123 and updated according to processing (to be described later) by the controller 12.

Additionally, it can be considered that the defective block includes a block (initial defective block), which is judged as being defective by the manufacturers of the flash memory 11 prior to shipment, and a block (late defective block), which is judged that data is not normally stored therein during use of the flash memory 11.

The logical/physical conversion table 61 stores information indicating a relationship between the logical group address of the group and the physical group address in connection with the respective groups. The logical/physical conversion table 61, for example, is prepared in advance in the nonvolatile storage area of the RAM 123 and updated according to processing (to be described later) by the CPU 121.

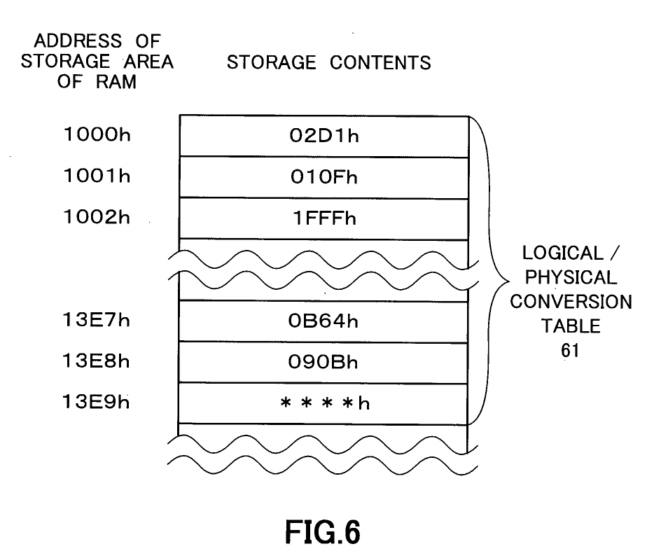

Specifically, the logical/physical conversion table 61 includes a data structure as illustrated in, for example, FIG. 6.

Namely, the logical/physical conversion table 61 is stored, for example, at a predetermined logical position in the nonvolatile storage area of the RAM 123. Then, the logical/physical conversion table 61 has a storage area for storing the physical group address associated with each logical group address. For example, when the total number of logical group addresses 8000, the logical/physical conversion table 61 may have a storage area of at least 13 bits for storing the physical group address associated with one logical group address. In this case, the logical/physical conversion table 61 may have a storage area of total 13000 bytes where addresses represented by, e.g., 1000h to 2F3Fh, are allocated for each 13 bits from the top.

When the logical/physical conversion table 61 has the data structure illustrated in FIG. 6, each address allocated to the storage area, which forms the logical/physical conversion table 61, is equal to a sum of the logical group address and a predetermined offset value. For example, FIG. 6 shows a case in which the offset value is “1000h.”

Then, the contents stored in the 13-bit storage area to which each address is allocated indicate the physical group address of the group associated with the logical group address shown by the corresponding address.

More specifically, as illustrated in, for example, FIG. 6, it is assumed that a value “010Fh” (binary “0000100001111”) is stored in a storage area to which an address 1001h is allocated and an offset value is 1000h. In this case, 0001h as a logical group address is associated with the group with the physical group address of 010Fh.

However, when the contents stored in the storage area to which each address is allocated is a predetermined value (for example, a value of physical group address is “1FFFh” as illustrated in the figure), this indicates the fact that the physical group address is not associated with the logical group address indicated by the address of the storage area that stores the value.

The writing pointer is a variable that is used when the CPU 121 designates a group to which user data should be written. More specifically, the writing pointer indicates the physical group address of the corresponding group. The value of the writing pointer is updated according to processing to be described later.

When this storage system is started and the user data is first written in the flash memory 11 by the controller 12, user data is written in the column of the physical group address indicated by an initial value of the writing pointer.

The moving destination writing pointer designates a block as a moving destination when the CPU 121 erases data in the block and moves a part of the data to another block. More specifically, the moving destination writing pointer indicates the physical group address of the group in the corresponding block. The value of the moving destination writing pointer is updated according to processing to be described later. Additionally, the writing pointer may be used as the moving destination writing pointer.

The empty block number counter indicates the number of existing empty blocks. An initial value of the empty block number counter is stored in advance in the nonvolatile storage are of the RAM 123 by, for example, the manufacturers of the memory unit 1. The value of the writing pointer is updated according to processing to be described later.

The computer 2 includes a general computer and stores program data of the OS and the driver. The computer 2 executes the OS on power-up. Then, the computer 2 starts the driver according to processing of the OS. Additionally, a processor of the computer 2 may execute a function as the CPU 121.

For example, the computer 2 inputs a writing command to the flash memory and user data to the CPU 121 of the memory unit 1. Then, the CPU 121 performs writing process (to be described later) according to the writing command. Namely, the computer 2 can write arbitrary user data in the flash memory 11.

Moreover, the computer 2 inputs a reading command from the flash memory to the CPU 121. Then, the CPU 121 performs reading process (to be described later) according to the reading command and supplies read user data to the computer 2. Namely, the computer 2 can read user data stored in the flash memory 11.

(Explanation of Operation)

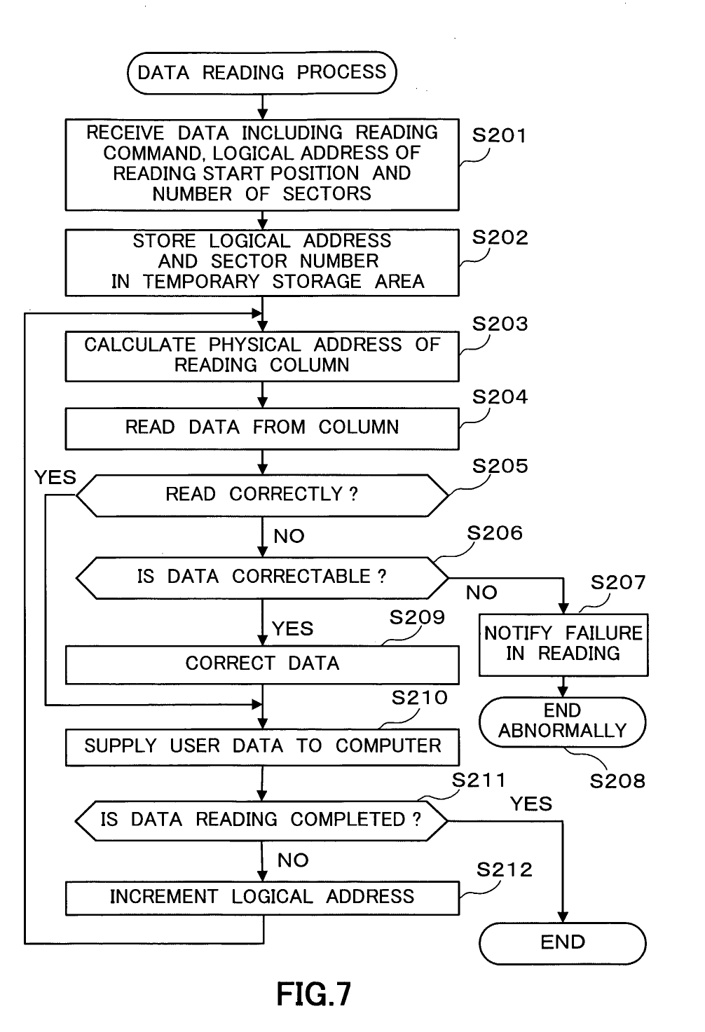

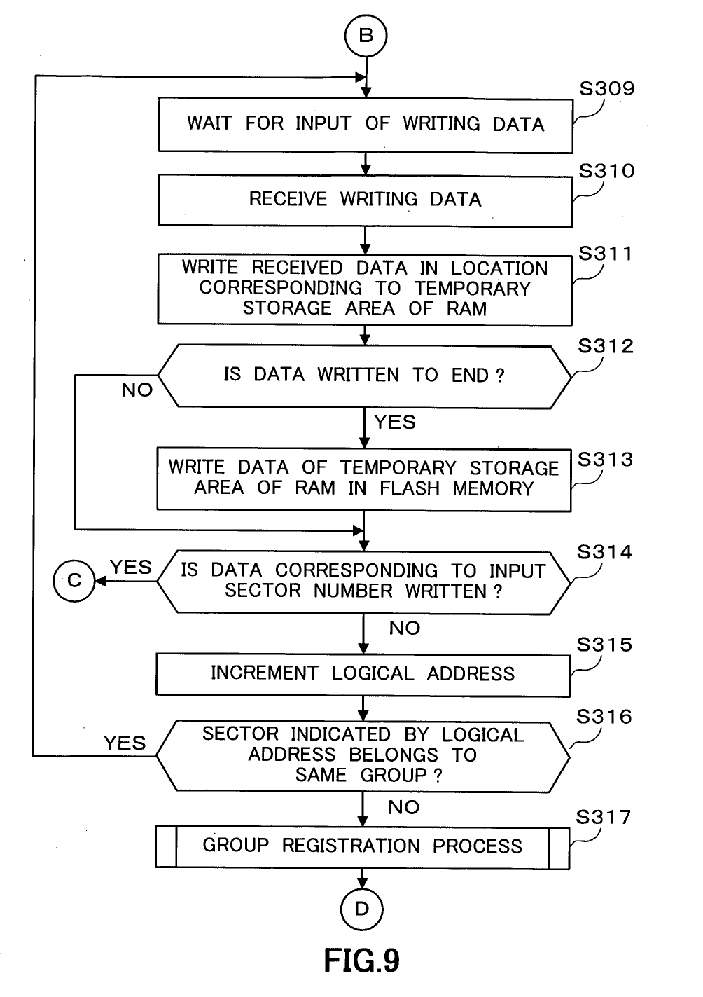

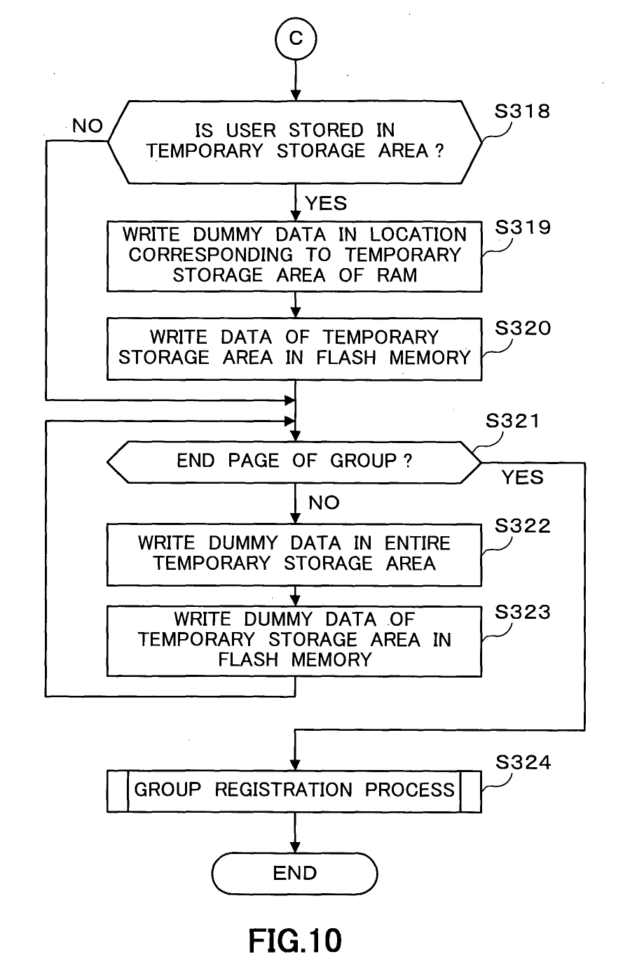

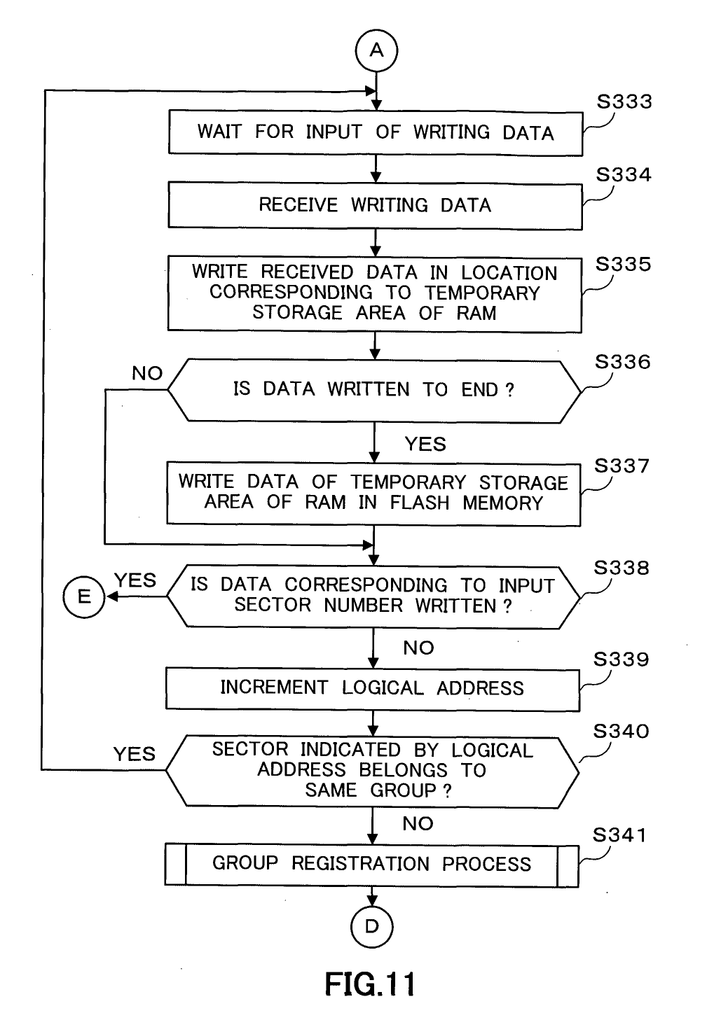

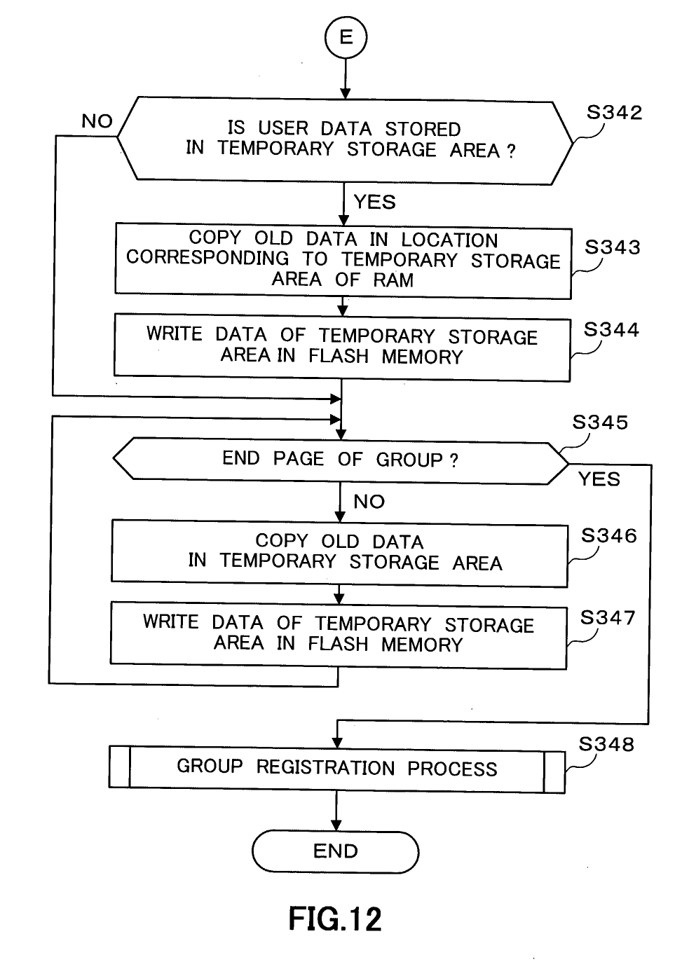

An explanation will be next given of an operation of this storage system with reference to FIGS. 7 to 14.

FIG. 7 is a flowchart illustrating data reading process.

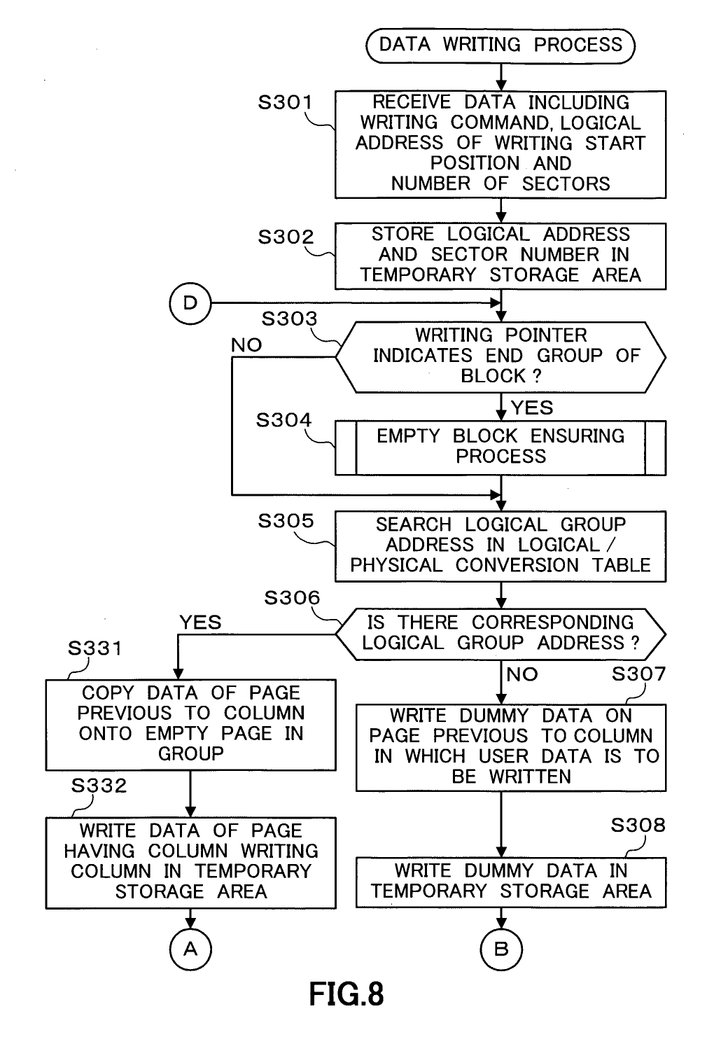

FIGS. 8 to 12 are flowcharts each illustrating data writing process.

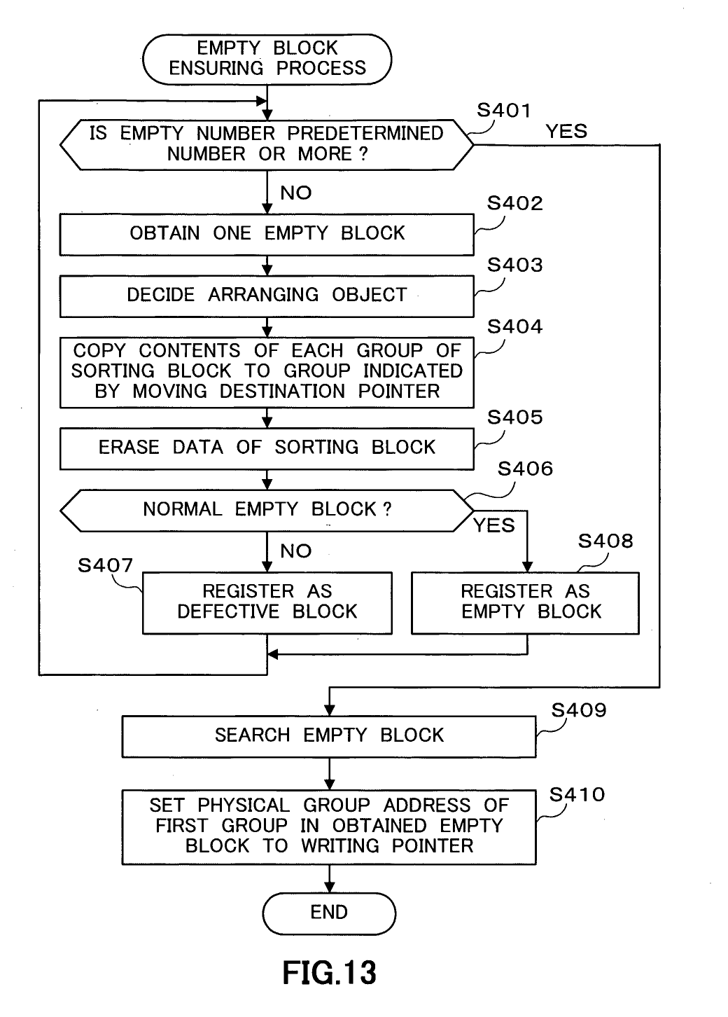

FIG. 13 is a flowchart illustrating empty block ensuring process.

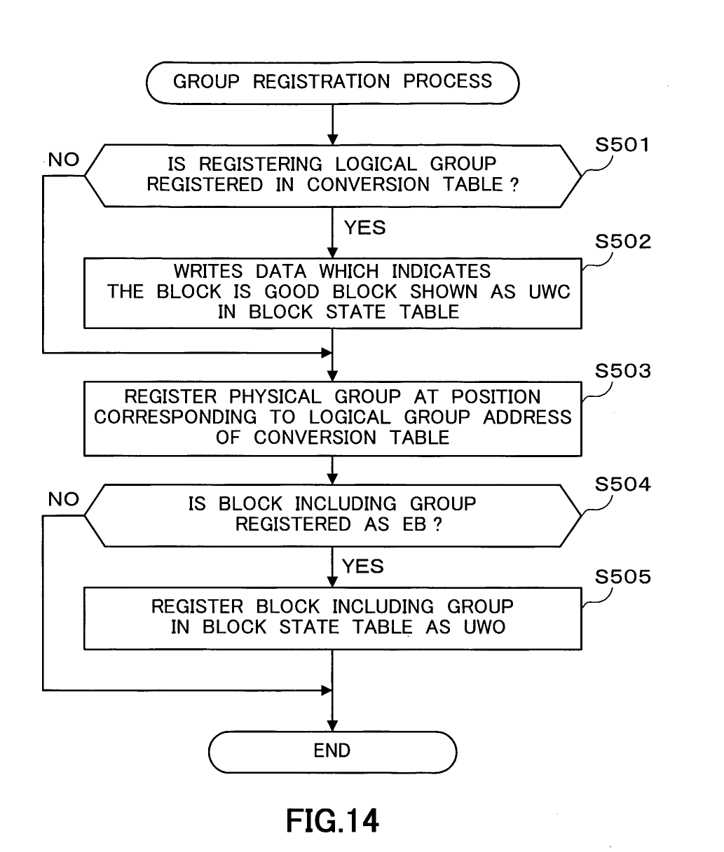

FIG. 14 is a flowchart illustrating group registration process.

(Data Reading Process)

The following will explain an operation in which the CPU 121 reads user data stored in the flash memory 11. When the user starts this storage system, the CPU 121 of the memory unit 1 goes into a state for receiving various commands for instructing access to the flash memory 11 from the computer 2. First of all, the computer 2 supplies data, which represents a predetermined reading command, a logical address of a first sector among sectors from which data is to be read and the number of reading sectors, to the CPU 121. The CPU 121 receives data including the predetermined reading command, the logical address of reading start position and the number of sectors (step S201).

Next, when detecting that the reading command is included in the input data, the CPU 121 stores the logical address and the number of sectors included in the supplied data in the temporary storage area of the RAM 123 (step S202). The CPU 121 performs search in the logical/physical conversion table 61 using the logical group address stored in the storage area indicated by the logical address. Then, the CPU 121 obtains a physical group address of a group to which a column, which corresponds to the first sector from which data is to be read, belongs. Moreover, the CPU 121 obtains a physical address of the column, which corresponds to the first sector from which data is to be read, based on the obtained physical group address, the column address included in the logical address supplied in step S201 and the inner group page address (step S203). Next, the CPU 121 reads data from the column obtained in step S203 (step S204). Then, the CPU 121 generates an ECC based on user data stored in the data area among read data. Moreover, the CPU 121 determines whether data stored in the data area is correctly read based on the generated ECC and the ECC stored in the redundant section among read data (step S205).

When determining that data is correctly read (step S205; YES), the CPU 121 supplies user data stored in the data area to the computer 2 (step S210).

When determining that data is not correctly read (step S205; NO), the CPU 121 determines whether data stored in the data area can be corrected to proper contents based on the ECC stored in the redundant section (step S206). Then, when determining that data can be corrected (step S206; YES), the CPU 121 corrects data stored in the data storage (step S209) and supplies the corrected data to the computer 2 (step S210).

When supplying user data stored in the data area of the column or data obtained by correcting the data to the computer 2 in step S210, the CPU 121 determines whether data reading from the columns corresponding to the number of sectors input in step S201 is completed (step S211). Then, when determining that data reading is completed (step S211; YES), the CPU 121 ends data reading process. When determining that data reading is not completed (step S211; NO), the CPU 121 increments the logical address temporarily stored in the RAM 123. Namely, the CPU 121 calculates a logical address indicating a next sector from which user data is to be read. Then, the CPU 121 repeats processing in steps S203 to S211.

When data read from the data area of the column cannot be corrected (step S206; NO), the CPU 121 writes data, which indicates that the block to which the column belongs is the defective block, in the block state table 51. Namely, the CPU 121 stores data indicating “BB” at a storing position indicating the status of the block in the block state table 51. Then, the CPU 121 notifies failure in reading data to the computer 2 (step S207).

The computer 2 ends data reading process upon reception of a notification indicating that the CPU 121 fails in reading data (step S208).

As mentioned above, the CPU 121 reads user data requested by the computer 2 from the flash memory 11 and inputs the read data to the computer 2.

Additionally, the computer 2 must calculate the logical address of the column in which reading data is stored based on the contents of the FAT and the directory. Accordingly, the computer 2 first instructs the CPU 121 to read the contents of the FAT and the directory. Then, the computer 2 inputs the logical address of the column in which reading data is stored.

(Data Writing Process)

Next, an operation in which the CPU 121 reads user data stored in the flash memory 11 will be explained with reference to FIGS. 8 to 12.

First of all, the computer 2 inputs data, which includes a predetermined writing command, a logical address of a first sector among sectors in which data is to be written and data indicating the number of writing sectors, to the CPU 121. The CPU 121 receives data including the writing command, the logical address of writing start position and the number of sectors (step S301).

When detecting that the writing command is included in the input data, the CPU 121 stores the logical address and the number of sectors included in the supplied data in the storage area of the RAM 123 (step S302).

Next, the CPU 121 determines whether the writing pointer indicates an end group of the block (step S303). Then, when determining that the writing pointer indicates a group of other than the end group (step S303; NO), processing goes to step S305. While, when determining that the writing pointer indicates the end group of the block (step S303; YES), empty block ensuring process (to be described later) is performed (step S304). Then, when empty block ensuring process is ended, processing goes to step S305. The CPU 121 performs search in the logical/physical conversion table 61 using the logical group address stored in the column indicated by the logical address stored in the RAM 123 (step S305). Namely, as illustrated in FIG. 6, in the logical/physical conversion table 61, one physical address is associated with one logical group address. Accordingly, the CPU 121 can obtain a physical group address using the logical group address included in the logical address of the sector input from the computer 2.

Then, the CPU 121 determines whether the logical group address of the column included in the logical address stored in the RAM 123 is in the logical/physical conversion table 61 (step S306).

When the logical group address is not searched (step S306; NO), the CPU 121 calculates the physical address of the column, which corresponds to the first sector in which user data is written, based on the physical group address actually indicated by the writing pointer, the logical address and the inner group page address of the column included the logical address input from the computer 2. Then, the CPU 121 writes predetermined dummy data on a page previous to the column in which user data is to be written (step S307). Namely, the CPU 121 initializes data of the column included in the page having the inner group page address smaller than the inner group page address of the page including the column in which user data is to be written.

Then, the CPU 121 writes the predetermined dummy data in the entire temporary storage area of the RAM 123 (step S308). Additionally, the case in which the logical group address is not searched in step S306 is a case in which user data, which is to be written in the flash memory 11 by the computer 2, is new data.

On the other hand, when the logical group address is searched in step S306 (step S306; YES), the CPU 121 obtains the physical address of the column, which corresponds to the first sector in which other data is already stored, based on the physical group address associated with the logical group address, the logical address and the inner group page address of the column included the logical address input from the computer 2. Then, the CPU 121 copies data stored on the page previous to the column onto an empty page in the group indicated by the writing pointer (step S331).

After that, the CPU 121 copies data of the page to which the column, in which data is to be rewritten, belongs, onto the temporary storage area of the RAM 123 (step S332).

The CPU 121 waits for user data, which is to be written in the flash memory 11, to be supplied from the computer 2 (steps S309 and S333). The size of user data input from the computer 2 is set within one sector. Then, the CPU 121 receives user data, which is to be written in the flash memory 11, from the computer 2 (step S310 or S334). The CPU 121 overwrites the received user data to a storage position corresponding to the data area of the column in which user data is to be written in the temporary storage area of the RAM 123 (step S311 or S335).

For example, it is assumed that the column, which is calculated by the CPU 121 and which corresponds to the first sector in which data is to be written, is a p-th column (p is an integral number including 1 to 4) from the top of the page. In this case, the CPU 121 overwrites user data received from the computer 2 to the storage area behind the storage area corresponding to a (p−1)-th column from the top of the temporary storage area of the RAM 123.

Next, the CPU 121 determines whether user data input from the computer 2 is overwritten to the end of the temporary storage area of the RAM 123 (step S312 or S336). Here, the case in which user data is not overwritten to the end of the temporary storage area means a case in which user data, which is not yet written in the flash memory 11, remains in the temporary storage area of the RAM 123.

Then, when user data is not overwritten to the end of the temporary storage area (step S312; NO or step S336; NO), the CPU 121 moves processing from step S312 to S314 (or from step S336 to step S338).

On the other hand, when user data is overwritten to the end of the temporary storage area (step S312; YES or step S336; YES), the CPU 121 writes data stored in the temporary storage area to a page next to the page in which data writing is performed last in the group indicated by the writing pointer (step S313 or S337). Moreover, the CPU 121 clears all data in the temporary storage area. Here, when data writing is performed for the first time in step S313, the block state table 51 is updated to show that a block to which a writing destination page belongs is in state (3). As explained above, the state (3) indicates the state in which the group where data is written and the group where no data is written are mixed.

Next, the CPU 121 determines whether data writing to the columns, which correspond to the number of sectors input from the computer 2, is completed (steps S314 or S338). Then, when determining that data writing is completed (step S314; YES or step S338; YES), the CPU 121 moves processing from step S314 to step S318 (or from step S338 to step S342).

On the other hand, when determining that data writing is not completed (step S314; NO or step S338; NO), the CPU 121 increments the logical address, which is stored in the temporary storage area of the RAM 123 and which is put from the computer 2 (step S315 or S339). Namely, the CPU 121 calculates a logical address indicating a next sector in which user data is to be written.

Next, the CPU 121 determines whether the sector, which is indicated by the calculated next logical address, belongs to the same group as the sector indicated by the uncalculating logical address (step S316 or S340). When determining that the sector belongs to the same group (step S316; YES or step S340; YES), the CPU 121 repeats processing in steps S309 to S315 (or steps S333 to S339).

On the other hand, when determining that the sector does not belong to the same group (step S316; NO or step S340; NO), the CPU 121 performs group registration process (to be described later) using a group, including a page corresponding to the sector indicated by the uncalculating logical address, as a registering group. Then, when group registration process is ended, processing goes to step S303, again.

When determining that writing process is ended in step S314 (step S314; YES), the CPU 121 determines whether user data, which is input last from the computer 2, is stored in the temporary storage area of the RAM 123 (step S318 or S342) as mentioned above. Then, when determining that user data is not stored (cleared) therein (step S318; NO, or step S342; NO), the CPU 121 moves processing from step S318 to step S321 (or from step S342 to step S345).

On the other hand, when determining that user data is stored (not cleared) therein (step S318; YES, or step S342; YES), the CPU 121 stores predetermined dummy data in a column where no user data is stored in the temporary storage area of the RAM 123 (step S319). Or, the CPU 121 copies old data, which is stored in a column next to the column in which user data is written, in a location corresponding to the temporary storage area of the RAM 123 (step S343).

Then, the CPU 121 writes data, which is stored in the temporary storage area of the RAM 123, on a page next to the page on which writing is performed last in the block indicated by the writing pointer (step S320 or S344).

Next, the CPU 121 determines whether the page on which data is written in step S320 or S344 is an end page of the group based on the logical address stored in the temporary storage area of the RAM 123 (step S321 or S345). Then, when determining that the page is not the end page of the group (step S321; NO or step S345; NO), the CPU 121 writes predetermined dummy data in the temporary storage area of the RAM 123 step S322). At this time, the size of predetermined dummy data written by the CPU 121 corresponds to one page. Or, the CPU 121 copies old data, which corresponds to one page, to the temporary storage area of the RAM 123 from a column next to the column in which user data is written (step S346)

Next, the CPU 121 writes data, which is stored in the temporary storage area of the RAM 123, onto a page next to the page where writing is performed last in the block indicated by the writing pointer in connection with the flash memory 11 (step S323 or S347). Then, the CPU 121 performs processing in step S321 (or processing to step S345) again.

On the other hand, when determining that the page is the end page of the group (step S321; YES or step S345; YES), the CPU 121 performs group registration process (to be described later) using the group including the end page as a registering group (step S342 or S348). Then, when group registration process is ended, data writing process is also ended.

(Empty Block Ensuring Process)

An explanation will be next given of empty block ensuring process using a flowchart of FIG. 13.

First of all, the CPU 121 determines whether the number of empty blocks of the flash memory 11 is a predetermined number or more based on a value of the empty block number counter (step S401).

When determining that the number of empty blocks is not the predetermined number or more (step S401; NO), the CPU 121 obtains one empty block, which is a good block, based on an empty block search position pointer (step S402). Then, the CPU 121 sets a physical group address of a first group in the obtained block to the moving destination writing pointer. Then, the CPU 121 decrements the value of the empty block number counter by one. Moreover, the CPU 121 obtains one another empty block and sets a physical block address of the empty block to the empty block search position pointer.

Next, the CPU 121 obtains blocks, which are in the aforementioned state (4b) (blocks shown by “UWC” in the block state table 51) based on the block state table 51. Then, the CPU 121 decides one or more blocks as new empty blocks (sorting blocks) among the obtained blocks (step S403).

Next, the CPU 121 copies data stored in a group, which effectively stores data, onto an empty block indicated by the moving destination writing pointer among the groups included in the sorting blocks decided in step S403 (step S404). Additionally, among the groups included in the sorting blocks, the group, which effectively stores data, is a group that does not include the column having the old group flag stored in the redundant section in group registration process (to be described later). Moreover, in step S404, the CPU 121 updates the logical/physical conversion table 61 in such a manner that logical group address of the group to which data is copied is associated with the physical group address of the group to which the storage position of the copy destination belongs.

When data copying from the sorting block to the empty block is completed, the CPU 121 erases data stored in the sorting block to change the sorting block to an empty block (step S405). Moreover, the CPU 121 obtains status information by the flash memory 11 and determines whether the sorting block is normally changed to the empty block (step S406). Then, when the sorting block is not changed to the empty block (step S406; NO), the CPU 121 writes data, which indicates that the sorting block is a defective block, in the block state table 51 (step S407). For example, the CPU 121 stores data indicating “BB” at the storage position indicating the status of the sorting block in the block state table 51. Then, the CPU 121 returns processing to step S401.

On the other hand, when the sorting block is normally changed to the empty block (step S406; YES), the CPU 121 writes data, which indicates that the sorting block is an empty, in the block state table 51 (step S408). For example, the CPU 121 stores data indicating “EB” at the storage position indicating the status of the sorting block in the block state table 51. Moreover, in step S408, the CPU 121 increments the value of the empty block number counter by the number of sorting blocks that are normally changed to the empty blocks. After that, the CPU 121 returns processing to step S401.

Then, when the number of empty blocks is increased to the predetermined number or more as a result of one or multiple processing in step S408 (step S401; YES), the CPU 121 moves processing from step S401 to step S409.

In other words, the CPU 121 performs search in the block state table 51 to obtain one empty block where data is newly written (step S409). After that, the CPU 121 sets the value of the physical group address of the first group in the obtained empty block to the writing pointer (step S410) and ends empty block ensuring process.

Additionally, in step S409, the empty block may be specified by reading data from each block of the flash memory 11. However, the empty block can be speedily specified by performing search in the block state table 51 as compared with reading data from each block. Moreover, this suppresses an increase in the number of access to the flash memory 11, allowing prevention of deterioration in the flash memory 11.

(Group Registration Process)

An explanation will be next given of group registration process using a flowchart of FIG. 14.

First of all, the CPU 121 determines whether a physical group address of a registering group is registered in the logical/physical conversion table 61 (step S501).

Then, when determining that the physical group address is registered (step S501; YES), the CPU 121 writes data, which indicates the block including the group indicated by the registered physical group address is in the aforementioned state (4b), in the block state table 51 (step S502).

Moreover, in step S502, when data copy or update is performed, the CPU 121 writes an old group flag in the redundant section of the column in the group which stores data, which newly becomes old data (for example, data of the transfer destination and non-updated data). Moreover, the CPU 121 reregisters a physical group address of the group, which stores new data (for example, data of the transfer destination and updated data) in place of the old data, in the logical/physical conversion table 61. Namely, the CPU 121 rewrites the physical group address of the group having old data to the physical group address of the group having new data.

On the other hand, when determining that the physical group address of the registering group is not registered (step S501; NO), the CPU 121 registers the nonregistered physical group address in the logical/physical conversion table 61 (step S503). Namely, the CPU 121 stores the physical group address at the storage position associated with the new logical address in the logical/physical conversion table 61.

When registering the physical group address in the logical/physical conversion table 61, the CPU 121 determines whether the block, which includes the group indicated by the registered physical group address, is registered as an empty block in the block state table 51 (step S504). Then, when determining that the block is not registered as the empty block (step S504; NO), the CPU 121 ends group registration process.

On the other hand, when determining that the block is registered as the empty block (step S504; YES), the CPU 121 stores data, which indicates, for example, “UWO”, at the storage position where the status of the block in the block state table 51 is shown (step S505), and ends group registration process. As a result of processing in step S505, the block state table 51 is updated in such a way to show that the block, which includes the group indicated by the registered physical group address, is in the aforementioned state (4a).

By the above-explained process, data supplied from the computer 2 is stored in the flash memory 11. Moreover, the contents of the block state table 51 are changed to the contents that reflect the block state newly caused as a result of data writing. While, the contents of the logical/physical conversion table 61 are also changed, so that the logical group address, which is allocated to the group in the block as the new empty block, is newly allocated to other group to which the contents of the group are transferred.

Since this storage system does not erase data stored in the blocks when the number of groups in which user data is not stored is sufficient, it is possible to prevent memory use efficiency from being reduced by erasing data. Accordingly, even when the storage capacity per block is large, deterioration in use efficiency of data stored in the flash memory 11 is not likely to occur. Moreover, the number of processing that is required to save data is reduced, making it smooth to access the flash memory 11.

Also, this storage system eliminates the need for an operation in which a new empty block is searched and user data is written to the new empty block every time when user data is written. Moreover, data erasing with poor efficiency to the block may not have to be performed at the time of writing user data. Furthermore, processing for copying data of an unchanged portion along with data writing is performed in units smaller than the block.

Accordingly, deterioration in efficiency of access to the flash memory 11 is not likely to occur, and access to the flash memory 11 becomes smooth.

Moreover, in this storage system, the relationship between the logical address and the physical address is managed in units smaller than the block and larger than the page or the column. Accordingly, the storage capacity of the table, which stores data indicating the relationship between the logical address and the physical address, can be reduced as compared with the case in which the management on the relationship between the logical address and the physical address is performed on a page-by-page or column-by-column basis. While, the management on the relationship between the logical address and the physical address is accurately performed as compared with the case in which the management is performed on a block-by-block basis, making it possible to store a large number of files.

Moreover, since the groups in which data is to be written are designated in order of the physical group address by the writing pointer, writing is prevented from being concentrated on a specific block. Accordingly, this prevents data erasing from being concentrated on the block where writing is concentrated. This contributes to prevention of deterioration in efficiency of access to the flash memory 11.

Additionally, the configuration of this storage system is not limited to the aforementioned configuration.

For example, the number of blocks in the storage area of the flash memory 11, the number of groups per one block, the number of pages per one group, the storage capacity of each page, the storage capacity of the data area, and the storage area of the redundant section are arbitrarily set. Moreover, the flash memory 11 is not limited to the EEPROM, and any computer-readable and writable storage device may be used. Furthermore, the logical address of the column in which the directory and FAT are stored is not limited to the aforementioned value. The number of columns in which the directory and FAT are stored is arbitrarily set. Moreover, the data area and the redundant section of one column are not always adjacent to each other. Accordingly, the storage area of the flash memory 11 may have a structure in which, for example, data areas of four columns are continuously formed in one page from the top and four redundant sections of four columns are continuously formed.

Additionally, the CPU 121 does not always update the block state table 51 after writing user data. Namely, the block state table 51 may be updated before writing user data at any time after how each bock state is changed by writing user data is decided.

Moreover, the CPU 121 is not always connected to the computer 2 via the internal bus. The CPU 121 may be connected to the computer 2 via a bus based on a PC card standard, an IEEE1394 interface, a USB (Universal Serial Bus), or other arbitrary interfaces. Furthermore, the CPU 121 is not always wire-connected to the computer 2. For example, the CPU 121 may be radio-connected to the computer 2 via an interface based on a standard such as Bluetooth.

Moreover, all digits of the physical group address do not have to be stored in the logical/physical conversion table 61. For example, a predetermined number of low-order digits of the physical group address may be stored as a temporary physical group address. The logical/physical conversion table 61 thus stores the temporary physical group address in place of all digits of the physical group address, thereby reducing the amount of data of the logical/physical conversion table 61 as compared with the case in which all digits of the physical group address are stored. Accordingly, the storage capacity of the RAM 123, which stores the logical/physical conversion table 61, may be small, making it possible to miniaturize the storage system.

Moreover, the RAM 123 may store a sorting block pointer indicating a physical block address of a block that is obtained as a sorting block in step S403. In this case, for example, in step S403, the CPU 121 uses the block having the physical block address, which is actually indicated by the sorting block pointer, as the sorting block. Then, regarding the physical block addresses of the blocks, which are in state (4b), after the corresponding physical address, the CPU 121 may cyclically set the physical block addresses. Namely, a physical block address, which has a larger value than the physical block address that is actually indicated by the sorting block pointer, and which has the smallest value of the physical block addresses of the blocks, which are in state (4b) (when there no physical block address that meets both, one having the smallest value of the physical block addresses of the blocks, which are in state (4b)), may be set to the sorting block pointer as a physical block address indicating a next sorting block.

In this way, the respective blocks are subjected to data erasing in ascending order in which data is written in the block, thereby equalizing the frequency of which data stored in the block is erased. Accordingly, this prevents the entire life of the flash memory 11 from being shortened by the concentrated use of the specific memory block.

Moreover, the RAM 123 may store a block search position pointer indicating a physical block address of a block that is obtained in step S410. In this case, the CPU 121 obtains an empty block having the physical block address, which is actually indicated by the empty block search position pointer. Furthermore, in step S410, the CPU 121 may cyclically set the physical block address of the empty block after the corresponding block address which is actually indicated by the empty block search position pointer. This structure equalizes the frequency of which data stored in the block is erased, and prevents access from being concentrated on the specific memory block.

When the temporary physical group address is formed of only a predetermined number of low-order digits of the physical group address, it is assumed that the groups of the flash memory 11 are classified into any one of multiple zones and that the high-order digits of the physical group address excluding the predetermined number of low-order digits indicate a zone to which the group belongs. Additionally, the size of the storage capacity of each zone may be larger or smaller than or equal to one block. Moreover, the zone may be conformed to the block.

Then, when the groups are classified into any one of multiple zones, it is assumed that each logical group address is allocated to the group belonging to any one of zones. Accordingly, the zone to which the group belongs can be specified based on the logical group address allocated to the group.

When the groups are classified into any one of multiple zones, in order to obtain a column in which data to be read and written is stored, the CPU 121 obtains the temporary physical group address associated with the logical group address included in the logical address of the column with reference to the logical/physical conversion table 61. Furthermore, the CPU 121 also obtains a zone to which the column belongs based on the logical group address. Next, the CPU 121 gains access to the column indicated by the physical address including the obtained zone, the obtained temporary physical group address and the inner group page address of the page to which the column belongs.

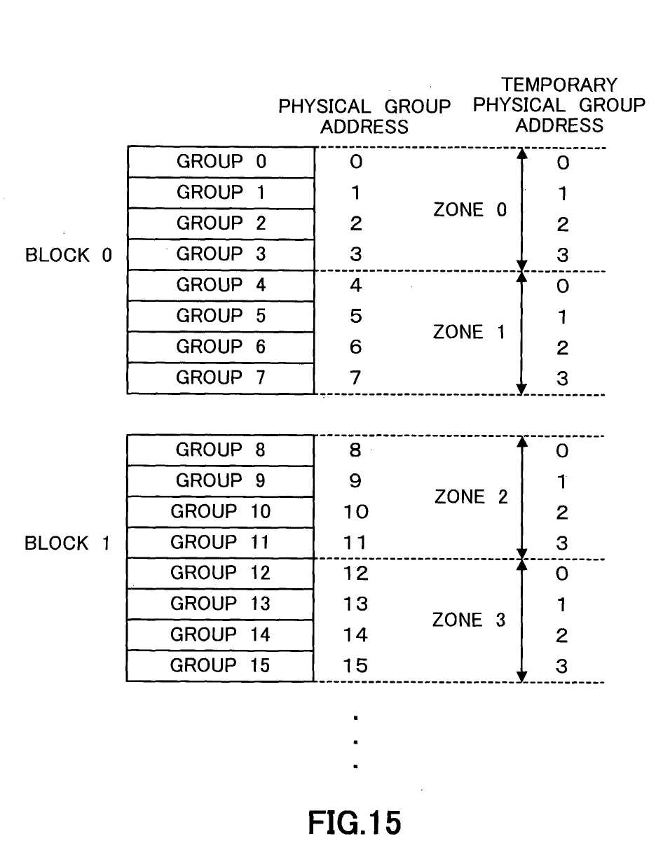

For example, FIG. 15 is a view illustrating the relationship between the physical group address and the temporary physical group address of the flash memory 11 when one memory block is composed of eight groups and four groups form one zone. In this case, the temporary physical group address is allocated for each zone. This makes it possible to designate one group using the zone number and the temporary physical group address without using the physical group address. For example, when the physical group address is 11, “second zone and third temporary physical group address” can be obtained.

Moreover, the logical/physical conversion table 61 may be stored in the flash memory 11. In this case, a logical/physical conversion table column list 171 may be prestored in the RAM 123. The logical/physical conversion table column list 171 indicates a position of a column (hereinafter called logical/physical conversion table storing column) in which data that forms the logical/physical conversion table 61 is stored.

Specifically, for example, the logical/physical conversion table column list 171 stores a logical address (hereinafter called logical/physical conversion table storing column pointer) of the logical/physical conversion table storing column and a physical address of the logical/physical conversion table storing column to be associated with each other.

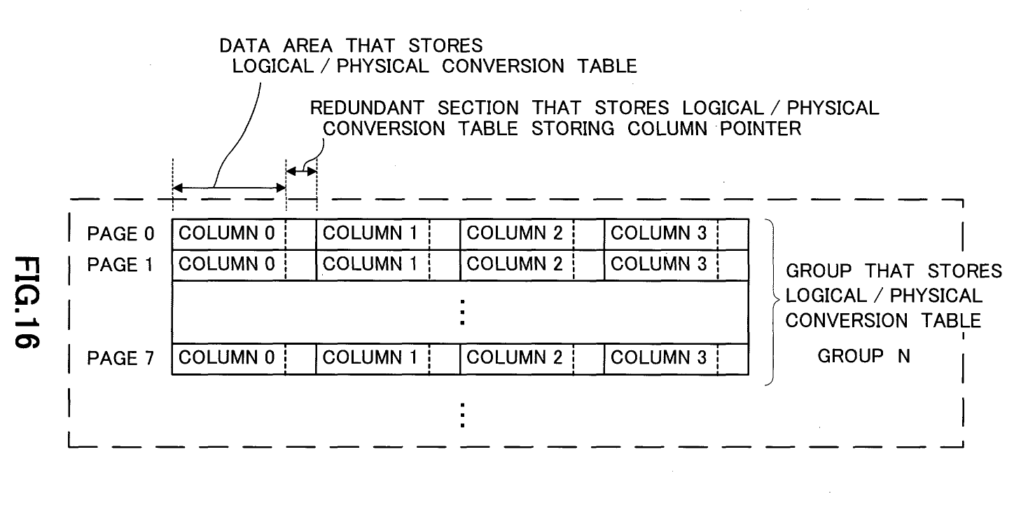

Moreover, the CPU 121 stores the logical/physical conversion table storing column pointer, which is allocated to the logical/physical conversion table storing column, in the redundant section of the logical/physical conversion table storing column. For example, FIG. 16 is a view illustrating an example of a case in which the logical/physical conversion table 61 is stored in a part of the flash memory 11. In this figure, the logical/physical conversion table 61 is stored in each of pages 0 to 7 of a group N. Then, the logical/physical conversion table 61 is stored in the data area of each column, and the logical/physical conversion table storing column pointer is stored in the redundant section of each column.

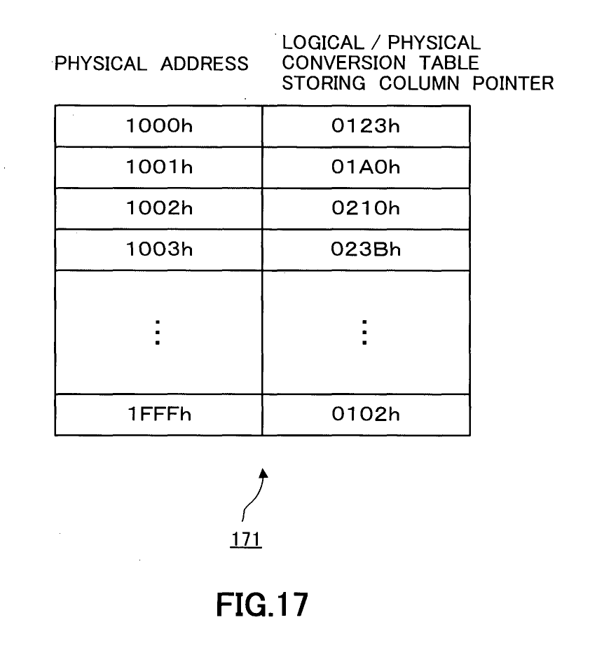

While, the RAM 123 stores the logical/physical conversion table column list 171 as illustrated in FIG. 17. In this figure, in the logical/physical conversion table column list 171, the logical/physical conversion table 61 is stored in areas including physical addresses 1000 h to 1FFFh of the flash memory 11.

First of all, the CPU 121 reads the logical/physical conversion table column list 171 as illustrated in FIG. 17 from the RAM 123 in place of processing in step S207 in order to refer to the logical/physical conversion table 61 in data reading process. Next, the CPU 121 reads data stored in the logical/physical conversion table 61, which is stored in the data area as illustrated in FIG. 16, from the column indicated by the physical address associated with the logical/physical conversion table storing column pointer included in the logical/physical conversion table column list 171. Then, the CPU 121 obtains a physical group address using the read data.

While, in updating the contents of the logical/physical conversion table 61 in data writing process, the CPU 121 reads the logical/physical conversion table 61 from the flash memory 11 when updating the contents of the logical/physical conversion table 61 in data writing process. Next, the CPU 121 temporarily stores the contents of the read logical/physical conversion table 61 in the RAM 123. Furthermore, the CPU 121 updates the contents of the temporarily-stored logical/physical conversion table 61, and writes the rewritten logical/physical conversion table 61 in the group indicated by the writing pointer. Moreover, the CPU 121 stores the physical address of each column, in which data that forms the logical/physical conversion table 61 is newly written, in the logical/physical conversion table column list 171 to be associated with the logical/physical conversion table storing column pointer that indicates the column in which data is previously stored. On the other hand, the CPU 121 deletes the physical address associated with the logical/physical conversion table storing column pointer from the logical/physical conversion table column list 171.

Moreover, a value of the logical/physical conversion table storing column pointer, which indicates the page that stores the logical/physical conversion table 61 may be one in which data stored in the logical/physical conversion table storing column indicates which range of the logical group address in the logical/physical conversion table 61. In this case, the CPU 121 obtains a portion including the logical group address of the group to which the column, which stores data to be read and written, belongs in the logical/physical conversion table 61 based on the contents of the logical/physical conversion table column list 171. Then, the CPU 121 may read the obtained portion from the flash memory 11, temporarily store the read portion in the RAM 123, and treat the temporarily-stored portion as the logical/physical conversion table 61.

The aforementioned process eliminates the need for an operation in which the entire logical/physical conversion table 61 is read from the flash memory 11 when the logical/physical conversion table 61 is referenced, thereby shortening time required for referring to the logical/physical conversion table 61.

Moreover, the block state table 51 may be stored in the flash memory 11. In this case, the CPU 121 stores a block state table column list 191 indicating a position of a column (hereinafter called block state table storing column) in which data that forms the block state table 51 is stored.

Specifically, for example, the block state table column list 191 stores a logical address (hereinafter called block state table storing column pointer) of the block state table storing column and a physical address of the block state table storing column 1 to be associated with each other.

While, the CPU 121 stores the block state table storing column pointer in the redundant section of the block state table storing column.

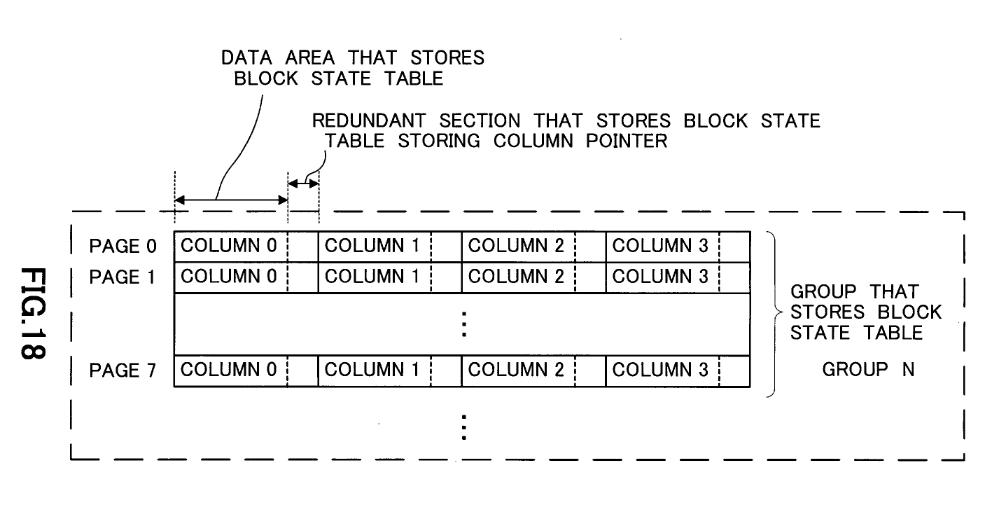

For example, FIG. 18 is a view illustrating an example of a case in which the block state table 51 is stored in a part of the flash memory 11. In this figure, the block state table 51 is stored in each of pages 0 to 7 of a group N. Then, the block state table 51 is stored in the data area of each column, and the block state table storing column pointer is stored in the redundant section of each column.

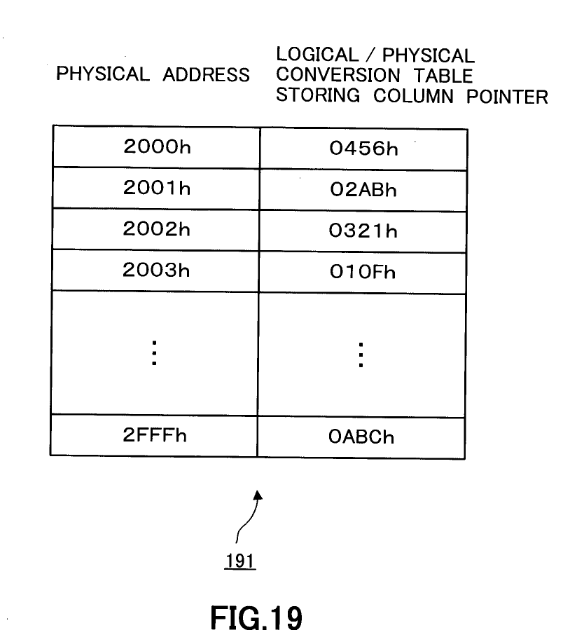

While, the RAM 123 stores the block state table column list 191 as illustrated in FIG. 19. In this figure, in the block state table column list 191, the block state table 51 is stored in areas including physical addresses 2000h to 2FFFh of the flash memory 11.

First of all, in updating the contents of the block state table 51 in data writing process, the CPU 121 reads the block state table 51 from the flash memory 11. Next, the CPU 121 temporarily stores the read block state table 51 in the RAM 123. Furthermore, the CPU 121 updates the contents of the temporarily-stored block state table 51, and writes the rewritten block state table 51 in the group indicated by the writing pointer.

Moreover, the CPU 121 stores the physical address of each column, which stores the block state table 51 in which data is newly written, in the block state table column list 191 to be associated with the block state table storing column pointer that indicates the column in which the block state table 51 is stored as illustrated in FIG. 19. On the other hand, the CPU 121 deletes the physical address associated with the block state table storing column pointer from the block state table column list 191.

Additionally, when data, which forms the block state table 51, is stored in any one predetermined zone of the aforementioned zones, the CPU 121 may store the temporary physical group address in the block state table column list 191. In this case, in the block state table column 191, the temporary physical group address, which indicates the position of the group to which the table state table storing column belongs in the zone, is stored in place of the physical group address of the group to which the block state table storing column that stores the data. This reduces an amount of data in the block state table column list 191 as compared with the case in which all digits of the physical group address are stored. Accordingly, the storage capacity of the RAM 123 may be small to make it possible to miniaturize the storage system.

Moreover, a value of the block state table storing column pointer may be one in which data stored in the block state table storing column indicates which range of the logical group address in the block state table 51. In this case, the CPU 121 obtains a portion including the logical group address of the column, which stores data to be read and written, in the block state table 51 based on the contents of the block state table column list 191. Then, the CPU 121 may read the obtained portion from the flash memory 11, temporarily store the read portion in the RAM 123, and treat the temporarily-stored portion as the block state table 51.

The aforementioned process eliminates the need for an operation in which the entire block state table 51 is read from the flash memory 11 when the block state table 51 is referenced, thereby shortening time required for referring to the block state table 51.

Furthermore, the data structure of the block state table 51 is not limited to the aforementioned structure. For example, the block state table 51 may store one-bit information, which indicates whether each block included in the storage area of the flash memory 11 is an empty block, to be associated with the physical block address of the block.

However, in this case, the CPU 121 writes, for example, predetermined identifying data (for example, a logical address of the column), which indicates that user data is written, in the redundant section of the column subjected to writing in order to determine in which state of the aforementioned states (3), (4a) and (4b) the block is. Then, the CPU 121 searches the identifying data and the old group flag in the block to determine in which state of the aforementioned states (3), (4a) and (4b) the block is.

Additionally, when the logical address of the column is written in the redundant section of each column in which user data is written, the CPU 121 reads each logical address written in the redundant section to extract the logical group address and obtains a relationship between the logical group address of the group to which the column belongs and the physical group address. Accordingly, for example, the CPU 121 reads the logical address, which is written in the redundant section of each column of the flash memory 11 just after the storage system is started. Then, the CPU 121 may create a new logical/physical conversion table 61 based on the read contents and store the new logical/physical conversion table 61 in the RAM 123. In this case, the RAM 123 does not have to include the nonvolatile storage area that stores the logical/physical conversion table 61.

Moreover, for example, when erasing data stored in the block, the CPU 121 may write a predetermined empty block code in the redundant section of the column in the block as the new empty block. In this case, the CPU 121 can specify the empty block by searching the empty block code written in the redundant section. Accordingly, for example, the CPU 121 searches the empty block code written in the redundant section of each column of the flash memory 11 just after the storage system is started. Then, the CPU 121 may create a new block state table 51 based on the searching result and store the new block state table 51 in the RAM 123. However, in this case, the block state table 51 may store one-bit information, which indicates whether each block included in the storage area of the flash memory 11 is an empty block, to be associated with the physical block address of the block.

Additionally, when the CPU 121 performs processing for creating a new block state table 51, the RAM 123 does not have to include the nonvolatile memory for providing the nonvolatile storage area that stores the block state table 51.

Although the above has explained the embodiment of the present invention, the storage system of the present invention can be implemented using the general computer system without using a dedicated system. For example, the storage system, which executes the aforementioned process, can be achieved by installing a program for causing a personal computer, having a slot for inserting the flash memory 11, to execute the aforementioned operation from a medium (flexible disk, CD-ROM, etc.) on which such the program is stored.

Moreover, for example, the program may be uploaded to BBS of the communication channel to distribute the program via the communication channel. Moreover, a carrier wave is modulated by a signal representing the program and the obtained modulation wave is transmitted, so that an apparatus that receives the modulation wave may demodulate the modulation wave to restore the program.

Then, the program is started and executed in the similar way as the other application program under control of OS, thereby enabling to execute the aforementioned process.

Additionally, when the OS shares a part of processing or configures a part of one configuration element of the present invention, a program excluding the corresponding part may be stored on a recording medium. In this case, according to the present invention, it is assumed that a program for causing the computer to execute the respective functions or steps is stored on the recording medium.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2004-263995 filed on Sep. 10, 2004 and including specification, claims, drawings and summary. The disclosure of the above Japanese Patent Application is incorporated herein by reference in its entirety.

1. A storage device comprising:
a storing section (11) including multiple memory blocks as storage areas for storing user data, each memory block being formed by combining multiple groups each having a storage capacity smaller than the memory block, and each group being formed by combining multiple pages each having a storage capacity smaller than the group;
a table storing section (123) that stores a first table (61) for associating a physical group address indicating a physical position of the group in the storage area with a logical group address indicating a logical position of the group;
a pointer storing section (123) that obtains an empty group where user data is storable from the group to store a pointer indicating a physical group address of the obtained empty group;
a writing section (12), upon supply of the user data, a logical group address indicating a group in which the user data is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61); and
a storing section (123) that stores a second table (51) including information for identifying whether an empty block is included in the memory block,
wherein
the second table (51) further includes information for identifying whether unnecessary user data is included in each memory block,
the writing section (12) comprises:
a user data invalidating section (12) that associates the logical group address of the group to which a storage position where new user data is written belongs with data indicating that user data stored at other storage position designated by the inner group address of the storage position is unnecessary data;
an erasing target designating section (12) that designates a memory block where data should be erased from the memory blocks that store user data determined as being unnecessary by the user data invalidating section (12);
an erasing section (12) that determines whether user data stored in the memory block designated by the erasing target designating section (12) is necessary, and transfers the user data to another memory block when determining as being necessary, and further erases data stored by the memory block designated by the erasing target designating section (12);
a first updating section (12) that writes information indicating that the memory block includes no empty group in the second table (51) when the empty group is eliminated from the memory block including the group as a result of writing the supplied user data to the empty block;
a second updating section (12) that writes information, indicating that the memory block from which data is erased by the erasing section (12) includes an empty block, in second table (51); and
an empty block number determining section (12) that determines whether the number of memory blocks including the empty group meets a predetermined condition,
the user data invalidating section (12) includes a writing section (12) that writes information, indicating that unnecessary user data is stored in the memory block including the other storage position designated by the logical group address of the group to which the storage position in which new user data is written belongs and the inner group address of the storage position, in the second table (51), and
the erasing target designating section (12) designates a target memory block from which data should be erased from the memory blocks where information indicating that no empty group is included is written in the second table (51), and designates a target memory block from which data should be erased from the memory blocks that store unnecessary user data when determining that the number of memory blocks including the empty group does not meet the predetermined condition.

2. A storage device comprising:
a storing section (11) including multiple memory blocks as storage areas for storing user data, each memory block being formed by combining multiple groups each having a storage capacity smaller than the memory block, and each group being formed by combining multiple pages each having a storage capacity smaller than the group;
a table storing section (123) that stores a first table (61) for associating a physical group address indicating a physical position of the group in the storage area with a logical group address indicating a logical position of the group;
a pointer storing section (123) that obtains an empty group where user data is storable from the group to store a pointer indicating a physical group address of the obtained empty group;
a writing section (12), upon supply of the user data, a logical group address indicating a group in which the user data is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61); and
a storing section (123) that stores a second table (51) including information for identifying whether an empty block is included in the memory block,
wherein
the physical group address is cyclically assigned ranking and includes a block address indicating a block to which the group indicated by the physical group address belongs,
the second table (51) further includes information for identifying whether unnecessary user data is included in each memory block,
the writing section (12) comprises:
a user data invalidating section (12) that associates the logical group address of the group to which a storage position where new user data is written belongs with data indicating that user data stored at other storage position designated by the inner group address of the storage position is unnecessary data;
an erasing target designating section (12) that designates a memory block where data should be erased from the memory blocks that store user data determined as being unnecessary by the user data invalidating section (12);
an erasing section (12) that determines whether user data stored in the memory block designated by the erasing target designating section (12) is necessary, and transfers the user data to another memory block when determining as being necessary, and further erases data stored by the memory block designated by the erasing target designating section (12);
a first updating section (12) that writes information indicating that the memory block includes no empty group in the second table (51) when the empty group is eliminated from the memory block including the group as a result of writing the supplied user data to the empty block; and
a second updating section (12) that writes information, indicating that the memory block from which data is erased by the erasing section (12) includes an empty block, in second table (51),
the user data invalidating section (12) includes a writing section (12) that writes information, indicating that unnecessary user data is stored in the memory block including the other storage position designated by the logical group address of the group to which the storage position in which new user data is written belongs and the inner group address of the storage position, in the second table (51), and
the erasing target designating section (12) designates a target memory block from which data should be erased from the memory blocks where information indicating that no empty group is included is written in the second table (51), and designates a block, having a first block address after a block from which data is erased last among the memory blocks that store unnecessary user data, as a target block from which data should be erased.

3. (canceled)

4. The storage device according to claim 1,
wherein the writing section (12) comprises an empty block number determining section (12) that determines whether the number of memory blocks including the empty group meets a predetermined condition; and
wherein the erasing target designating section (12) designates a target memory block from which data should be erased from the memory blocks that store unnecessary user data when determining that the number of memory blocks including the empty group does not meet the predetermined condition.

5. (canceled)

6. (canceled)

7. The storage device according to claim 1,
wherein the physical group address is cyclically assigned ranking; and wherein the pointer storing section (123) obtains a first empty group among empty groups each having a physical group address after physical group addresses of the group where a page in which user data can be stored is eliminated as a result of writing the user data.

8. The storage device according to claim 1, further comprising:
a reading section (12), upon supply of a logical group address of a group in which user data is to be read, and an inner group address that designates a storage position in which the user data is stored in a page belonging to the group, that obtains a physical group address associated with the logical group address based on an address conversion table and further reads user read from the storage position designated by the inner group address in the page belonging to the group indicated by the obtained physical group address.

9. The storage device according to claim 1, further comprising:
a code generating section (12) that performs mathematical computations based on the contents of storing user data to generate an error correction code; and
a code storing section (11) that stores the error correction code generated by the code generating section (12),
wherein the reading section (12) determines whether the user data is correctly read based on the read user data and the error correction code stored by the code storing section (11), and restores the user data based on the error correction code to replace the restored data with user data when the user data is not correctly read.

10. The storage device according to claim 1,
wherein the page includes one or more columns, and wherein the inner group address at the storage position of the column includes an inner group page address that designates a logical position of a page including the column in the group and a column address that designates a logical position of the column in the page,

11. The storage device according to claim 1,
wherein the physical group address stored by the first table (61) includes a physical address allocated for each set of groups and an address indicating a logical position in the set of groups.

12. The storage device according to claim 1,
wherein the first table (61) is stored in the storing section (123),
wherein the storage device further comprise a list storing section (123) that stores a list for associating a physical address of a table storage area that stores the first table (61) with an address indicating a logical position in the table storage area, and
wherein the writing section (12) acquires the physical address based on the address indicating the logical position in the table storage area, and obtains the logical group address based on the data stored in the storage area corresponding to the acquired physical address.

13. The storage device according to claim 1, further comprising:
a second pointer storing section (123) that obtains an empty group being in a state that stored user data can be copied from the group to store a pointer indicating a physical group address of the obtained empty group, and
wherein the writing section (12) copies the user data to the empty group indicated by the pointer stored by the second storing section (123) when the stored user data is copied to the empty group, and further writes data, which associates the logical group in which the user data is stored with the physical group address of the empty group, in the table.

14. A memory management method for managing a storing section (11) including multiple memory blocks as storage areas for storing user data, each memory block being formed by combining multiple groups each having a storage capacity smaller than the memory block, and each group being formed by combining multiple pages each having a storage capacity smaller than the group; the memory management method comprising:
the first table storing step of storing a first table (61) for associating a physical group address indicating a physical position of the group in the storage area with a logical group address indicating a logical position of the group;
the pointer storing step of obtaining an empty group where user data is storable from the group to store a pointer indicating a physical group address of the obtained empty group;
the writing step, upon supply of the user data, a logical group address indicating a group in which the user data is to be written, an inner group address indicating a storage position where the user data in a page belonging to the group, of writing the user address at the storage position indicated by the inner group address of the page belonging to the empty group indicated by the pointer and further writing data for associating the physical group address of the empty group with the supplied logical group address in the first table (61); and
the second table storing step of storing a second table (51) including information for identifying whether an empty block is included in the memory block,
wherein
the second table (51) further includes information for identifying whether unnecessary user data is included in each memory block,
the writing step comprises:
the user data invalidating step of associating the logical group address of the group to which a storage position where new user data is written belongs with data indicating that user data stored at other storage position designated by the inner group address of the storage position is unnecessary data;
the erasing target designating step of designating a memory block where data should be erased from the memory blocks that store user data determined as being unnecessary at the user data invalidating step;
the erasing step of determining whether user data stored in the memory block designated at the erasing target designating step is necessary, and transferring the user data to another memory block when determining as being necessary, and further erasing data stored by the memory block designated at the erasing target designating step;
the first updating step of writing information indicating that the memory block includes no empty group in the second table (51) when the empty group is eliminated from the memory block including the group as a result of writing the supplied user data to the empty block;
the second updating step of writing information, indicating that the memory block from which data is erased at the erasing step includes an empty block, in second table (51); and
the empty block number determining step of determining whether the number of memory blocks including the empty group meets a predetermined condition,
the user data invalidating step includes the writing step of writing information, indicating that unnecessary user data is stored in the memory block including the other storage position designated by the logical group address of the group to which the storage position in which new user data is written belongs and the inner group address of the storage position, in the second table (51), and
the erasing target designating step designates a target memory block from which data should be erased from the memory blocks where information indicating that no empty group is included is written in the second table (51), and designates a target memory block from which data should be erased from the memory blocks that store unnecessary user data when determining that the number of memory blocks including the empty group does not meet the predetermined condition.

15. A program causing a computer, being connected to a storing section (11) including multiple memory blocks as storage areas for storing user data, each memory block being formed by combining multiple groups each having a storage capacity smaller than the memory block, and each group being formed by combining multiple pages each having a storage capacity smaller than the group, to execute:
the function as a table storing section (123) that stores a first table (61) for associating a physical group address indicating a physical position of the group in the storage area with a logical group address indicating a logical position of the group;
the function as a pointer storing section (123) that obtains an empty group where user data is storable from the group to store a pointer indicating a physical group address of the obtained empty group;
the function as a writing section (12), upon supply of the user data, a logical group address indicating a group in which the user data is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61); and
the function as a storing section (123) that stores a second table (51) including information for identifying whether an empty block is included in the memory block,
wherein
the second table (51) further includes information for identifying whether unnecessary user data is included in each memory block,
the writing section (12) comprises;
a user data invalidating section (12) that associates the logical group address of the group to which a storage position where new user data is written belongs with data indicating that user data stored at other storage position designated by the inner group address of the storage position is unnecessary data;
an erasing target designating section (12) that designates a memory block where data should be erased from the memory blocks that store user data determined as being unnecessary by the user data invalidating section (12);
an erasing section (12) that determines whether user data stored in the memory block designated by the erasing target designating section (12) is necessary, and transfers the user data to another memory block when determining as being necessary and further erases data stored by the memory block designated by the erasing target designating section (12);
a first updating section (12) that writes information indicating that the memory block includes no empty group in the second table (51) when the empty group is eliminated from the memory block including the group as a result of writing the supplied user data to the empty block;
a second updating section (12) that writes information, indicating that the memory block from which data is erased by the erasing section (12) includes an empty block, in second table (51); and
an empty block number determining section (12) that determines whether the number of memory blocks including the empty group meets a predetermined condition,
the user data invalidating section (12) includes a writing section (12) that writes information, indicating that unnecessary user data is stored in the memory block including the other storage position designated by the logical group address of the group to which the storage position in which new user data is written belongs and the inner group address of the storage position, in the second table (51), and
the erasing target designating section (12) designates a target memory block from which data should be erased from the memory blocks where information indicating that no empty group is included is written in the second table (51), and designates a target memory block from which data should be erased from the memory blocks that store unnecessary user data when determining that the number of memory blocks including the empty group does not meet the predetermined condition.

16. A memory management method for managing a storing section (11) including multiple memory blocks as storage areas for storing user data, each memory block being formed by combining multiple groups each having a storage capacity smaller than the memory block, and each group being formed by combing multiple pages each having a storage capacity smaller than the group; the memory management method comprising:
the first table storing step of storing a first table (61) for associating a physical group address indicating a physical position of the group in the storage area with a logical group address indicating a logical position of the group;
the pointer storing step of obtaining an empty group where user data is storable from the group to store a pointer indicating a physical group address of the obtained empty group;
the writing step, upon supply of the user data, a logical group address indicating a group in which the user data is to be written, an inner group address indicating a storage position where the user data in a page belonging to the group, of writing the user address at the storage position indicated by the inner group address of the page belonging to the empty group indicated by the pointer and further writing data for associating the physical group address of the empty group with the supplied logical group address in the first table (61); and
the second table storing step of storing a second table (51) including information for identifying whether an empty block is included in the memory block,
wherein
the physical group address is cyclically assigned ranking and includes a block address indicating a block to which the group indicated by the physical group address belongs,
the second table (51) further includes information for identifying whether unnecessary user data is included in each memory block,
the writing step comprises:
the user data invalidating step of associating the logical group address of the group to which a storage position where new user data is written belongs with data indicating that user data stored at other storage position designated by the inner group address of the storage position is unnecessary data;
the erasing target designating step of designating a memory block where data should be erased from the memory blocks that store user data determined as being unnecessary at the user data invalidating step;
the erasing step of determining whether user data stored in the memory block designated at the erasing target designating step is necessary, and transferring the user data to another memory block when determining as being necessary, and further erasing data stored by the memory block designated at the erasing target designating step;
the first updating step of writing information indicating that the memory block includes no empty group in the second table (51) when the empty group is eliminated from the memory block including the group as a result of writing the supplied user data to the empty block; and
the second updating step of writing information, indicating that the memory block from which data is erased at the erasing step includes an empty block, in second table (51),
the user data invalidating step includes the writing step of writing information, indicating that unnecessary user data is stored in the memory block including the other storage position designated by the logical group address of the group to which the storage position in which new user data is written belongs and the inner group address of the storage position, in the second table (51), and
the erasing target designating step designates a target memory block from which data should be erased from the memory blocks where information indicating that no empty group is included is written in the second table (51), and designates a block, having a first block address after a block from which data is erased last among the memory blocks that store unnecessary user data, as a target block from which data should be erased.

17. A program causing a computer, being connected to a storing section (11) including multiple memory blocks as storage areas for storing user data, each memory block being formed by combining multiple groups each having a storage capacity smaller than the memory block, and each group being formed by combining multiple pages each having a storage capacity smaller than the group, to execute:
the function as a table storing section (123) that stores a first table (61) for associating a physical group address indicating a physical position of the group in the storage area with a logical group address indicating a logical position of the group;
the function as a pointer storing section (123) that obtains an empty group where user data is storable from the group to store a pointer indicating a physical group address of the obtained empty group;
the function as a writing section (12), upon supply of the user data, a logical group address indicating a group in which the user data is to be written, an inner group address indicating a storage position where the user data in a page belonging to the group, that writes the user address at the storage position indicated by the inner group address of the page belonging to the empty group indicated by the pointer and further writes data for associating the physical group address of the empty group with the supplied logical group address in the first table (61); and
the function as a storing section (123) that stores a second table (51) including information for identifying whether an empty block is included in the memory block,
wherein
the physical group address is cyclically assigned ranking and includes a block address indicating a block to which the group indicated by the physical group address belongs,
the second table (51) further includes information for identifying whether unnecessary user data is included in each memory block,
the writing section (12) comprises:
a user data invalidating section (12) that associates the logical group address of the group to which a storage position where new user data is written belongs with data indicating that user data stored at other storage position designated by the inner group address of the storage position is unnecessary data;
an erasing target designating section (12) that designates a memory block where data should be erased from the memory blocks that store user data determined as being unnecessary by the user data invalidating section (12);
an erasing section (12) that determines whether user data stored in the memory block designated by the erasing target designating section (12) is necessary, and transfers the user data to another memory block when determining as being necessary, and further erases data stored by the memory block designated by the erasing target designating section (12);
a first updating section (12) that writes information indicating that the memory block includes no empty group in the second table (51) when the empty group is eliminated from the memory block including the group as a result of writing the supplied user data to the empty block; and
a second updating section (12) that writes information, indicating that the memory block from which data is erased by the erasing section (12) includes an empty block, in second table (51),
the user data invalidating section (12) includes a writing section (12) that writes information, indicating that unnecessary user data is stored in the memory block including the other storage position designated by the logical group address of the group to which the storage position in which new user data is written belongs and the inner group address of the storage position, in the second table (51), and
the erasing target designating section (12) designates a target memory block from which data should be erased from the memory blocks where information indicating that no empty group is included is written in the second table (51), and designates a block, having a first block address after a block from which data is erased last among the memory blocks that store unnecessary user data, as a target block from which data should be erased.
